(19) United States
(12) Patent Application Publication
(10) Pub. No.: US 2025/0316226 A1
(43) Pub. Date: Oct. 9, 2025

(54) Display driver circuit and host processor and related display system for deburn-in compensation

(71) Applicant: NOVATEK Microelectronics Corp., Hsin-Chu (TW)

(72) Inventors: Xuan-Yong Lin, Hsinchu City (TW); Feng-Ting Pai, Hsinchu City (TW); Chien-Yu Chen, Hsinchu County (TW); Shang-Yu Su, Hsinchu County (TW); Yung-Cheng Tsai, Hsinchu City (TW); Yao-Jen Chang, Changhua County (TW)

(73) Assignee: NOVATEK Microelectronics Corp., Hsin-Chu (TW)

(21) Appl. No.: 18/919,373

(22) Filed: Oct. 17, 2024

Related U.S. Application Data
(60) Provisional application No. 63/631,456, filed on Apr. 9, 2024.

(51) Int. Cl. G09G 3/3233; G09G 3/36

(52) U.S. Cl. CPC G09G 3/3233; G09G 3/3648; G09G 2300/0819; G09G 2320/0233; G09G 2320/046; G09G 2330/021; G09G 2360/16

(57) ABSTRACT

A display driver circuit includes a receiver, a memory and a compensation circuit. The receiver receives an original image data and a compensation data from a host processor. The memory stores the compensation data. The compensation circuit, coupled to the memory and the receiver, reads out the compensation data from the memory, and compensates the original image data by using the compensation data to generate a first compensated image data.

### CROSS REFERENCE TO RELATED APPLICATIONS

This application claims the benefit of U.S. Provisional Application No. 63/631,456, filed on Apr. 9, 2024. The content of the application is incorporated herein by reference.

### BACKGROUND OF THE INVENTION

### 1. Field of the Invention

The present invention relates to a display driver circuit and a host processor in a display system, and more particularly, to a display driver circuit and a host processor in a display system for deburn-in compensation.

### 2. Description of the Prior Art

The image uneven phenomenon of display devices currently on the market mainly comes from mura and burn-in. The so-called mura refers to the unevenness between pixels. When a display product is put into use, variations in processes and materials may cause inconsistent luminance or color cast between pixels. Therefore, during the manufacturing process of the display, demura is performed to remove the influence of mura. Burn-in means that after a display product is in use for a period of time, each pixel usually displays different images, causing different loads faced by different pixels or areas. In the long run, the burn-in would cause brightness inconsistencies between pixels on the panel. Therefore, during the display process of the panel, the burn-in effect should be removed through deburn-in processing.

However, due to the limited storage space and processing capability of a display driver integrated circuit (DDIC), the DDIC might not easily obtain the appropriate compensation value for deburn-in, and thus fails to accurately perform deburn-in compensation.

### SUMMARY OF THE INVENTION

It is therefore an objective of the present invention to provide a novel deburn-in compensation scheme for a display system, in which the display driver circuit and the host processor may cooperate to realize a satisfactory compensation result.

An embodiment of the present invention discloses a display driver circuit, which comprises a receiver, a memory and a compensation circuit. The receiver receives an original image data and a compensation data from a host processor. The memory stores the compensation data. The compensation circuit, coupled to the memory and the receiver, reads out the compensation data from the memory, and compensates the original image data by using the compensation data to generate a first compensated image data.

Another embodiment of the present invention discloses a host processor, which comprises a stress accumulator and a transmitter. The stress accumulator generates a stress value according to an original image data and accumulates the stress value to generate an accumulated stress value. The transmitter, coupled to the stress accumulator, sends a compensation data corresponding to the accumulated stress value and sends the original image data to a display driver circuit.

Another embodiment of the present invention discloses a display system, which comprises a host processor and a display driver circuit. The host processor comprises a stress accumulator and a transmitter. The stress accumulator generates a stress value according to an original image data and accumulates the stress value to generate an accumulated stress value. The transmitter, coupled to the stress accumulator, outputs a compensation data corresponding to the accumulated stress value and outputs the original image data. The display driver circuit comprises a receiver, a memory and a compensation circuit. The receiver receives the original image data and the compensation data from the host processor. The memory stores the compensation data. The compensation circuit, coupled to the memory and the receiver, reads out the compensation data from the memory, and compensates the original image data by using the compensation data to generate a compensated image data.

Another embodiment of the present invention discloses a display driver circuit, which comprises a receiver, a memory and a compensation circuit. The receiver receives an original image data from a host processor through a first interface. The memory receives a compensation data from the host processor through a second interface, and stores the compensation data. The compensation circuit, coupled to the memory and the receiver, reads out the compensation data from the memory, and compensates the original image data by using the compensation data to generate a first compensated image data.

Another embodiment of the present invention discloses a host processor, which comprises a stress accumulator, a first transmitter and a second transmitter. The stress accumulator generates a stress value according to an original image data and accumulates the stress value to generate an accumulated stress value. The first transmitter sends the original image data to a display driver circuit. The second transmitter, coupled to the stress accumulator, sends a compensation data corresponding to the accumulated stress value to the display driver circuit.

Another embodiment of the present invention discloses a display system, which comprises a host processor and a display driver circuit. The host processor comprises a stress accumulator, a first transmitter and a second transmitter. The stress accumulator generates a stress value according to an original image data and accumulates the stress value to generate an accumulated stress value. The first transmitter outputs the original image data through a first interface. The second transmitter, coupled to the stress accumulator, outputs a compensation data corresponding to the accumulated stress value through a second interface. The display driver circuit comprises a receiver, a memory and a compensation circuit. The receiver receives the original image data from the host processor through the first interface. The memory receives the compensation data from the host processor through the second interface, and stores the compensation data. The compensation circuit, coupled to the memory and the receiver, reads out the compensation data from the memory, and compensates the original image data by using the compensation data to generate a compensated image data.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a display system.

FIG. 2 illustrates a detailed implementation of handling deburn-in compensation through the DDIC in the display system.

FIG. 3 is a schematic diagram of a display system according to an embodiment of the present invention.

FIG. 4A is a schematic diagram of a display system according to an embodiment of the present invention.

FIG. 4B and FIG. 4C illustrate detailed implementations of the display system shown in FIG. 4A.

FIG. 5A is a schematic diagram of another display system according to an embodiment of the present invention.

FIG. 5B and FIG. 5C illustrate detailed implementations of the display system shown in FIG. 5A.

FIG. 6A is a schematic diagram of another display system according to an embodiment of the present invention.

FIG. 6B illustrates a detailed implementation of the display system shown in FIG. 6A.

FIGS. 7-9 are schematic diagrams of display systems according to embodiments of the present invention.

FIG. 10A is a schematic diagram of another display system according to an embodiment of the present invention.

FIG. 10B and FIG. 10C illustrate detailed implementations of the display system shown in FIG. 10A.

FIG. 11A is a schematic diagram of a display system according to an embodiment of the present invention.

FIG. 11B illustrates a detailed implementation of the display system shown in FIG. 11A.

FIG. 12A is a schematic diagram of a display system according to an embodiment of the present invention.

FIG. 12B illustrates a detailed implementation of the display system shown in FIG. 12A.

### DETAILED DESCRIPTION

In a display system, the display panel is generally controlled by a display driver circuit (such as a display driver integrated circuit (DDIC)). The image data to be displayed generally come from a host processor, which may be the central processing unit (CPU) of a laptop or tablet or may be the application processor (AP) of a mobile phone. To facilitate the illustrations, the display driver circuit will be referred to as DDIC hereinafter, and those skilled in the art would know that the DDIC described in this disclosure may represent a display driver circuit capable of driving a display panel and implemented in any manner. In addition, the host processor will be referred to as AP hereinafter, and those skilled in the art would know that the AP described in this disclosure may represent any type of processor or processing device capable of controlling the display operations and implemented in any manner.

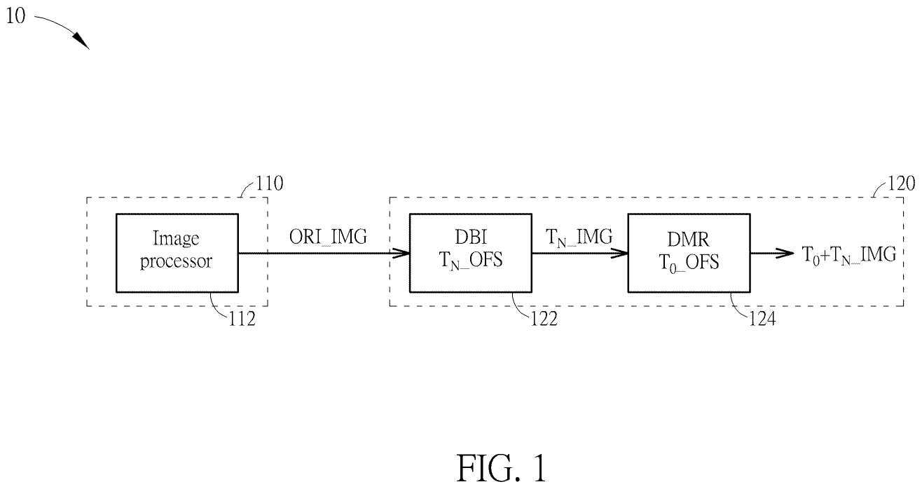

FIG. 1 is a schematic diagram of a display system 10. The display system 10 includes an AP 110 and a DDIC 120. The DDIC 120 may further be coupled to a display panel, which is omitted in FIG. 1 for brevity. In the display system 10, an image processor 112 of the AP 110 is configured to send the grayscale data or image data to be displayed to the DDIC 120, and then the processing circuits in the DDIC 120 may perform demura and deburn-in processing on the received grayscale data or image data to solve or improve the problem of uneven display images. In detail, the DDIC 120 may include a deburn-in (DBI) compensation circuit 122 and a demura (DMR) compensation circuit 124. The deburn-in compensation circuit 122 may provide a deburn-in offset value T_{N}_OFS for compensation of the timing T_{N}, where T_{N} represents the continuously generated burn-in and the corresponding compensation during the usage of the display panel; that is, N may be any time. The demura compensation circuit 124 may provide a demura offset value T₀_OFS for compensation of the timing T₀, where T₀ represents the mura generated at the initial time point and the corresponding demura compensation.

As shown in FIG. 1, the image data sent from the AP 110 to the DDIC 120 may be an uncompensated original image data ORI_IMG, which is first sent to the deburn-in compensation circuit 122 for deburn-in compensation. The deburn-in compensation circuit 122 may compensate the original image data ORI_IMG by using the deburn-in offset value T_{N}_OFS, to generate a deburn-in compensated image data T_{N}_IMG. The deburn-in compensated image data T_{N}_IMG refers to an image data that already undergoes the deburn-in compensation associated with the timing T_{N}. The deburn-in compensation circuit 122 then sends the deburn-in compensated image data T_{N}_IMG to the demura compensation circuit 124. The demura compensation circuit 124 may compensate the deburn-in compensated image data T_{N}_IMG by using the demura offset value T₀_OFS, to generate a full-time compensated image data T₀+T_{N}_IMG, which is then sent to the display panel.

When handling the demura compensation, it is necessary to first obtain the brightness difference between pixels through measurement and record the demura offset value T₀_OFS corresponding to this difference in a memory, so that the demura compensation circuit 124 may read out the correct demura offset value T₀_OFS from the memory to perform compensation when the image data needs to be output. As for deburn-in compensation, the data amount that needs to be processed by the deburn-in compensation circuit 122 is much larger than that of demura compensation, however. This is because the burn-in phenomenon comes from the images displayed during the usage of the display panel. Due to the differences in image content, different stresses are applied to different pixels in the long run, resulting in different degrees of degradation of pixels. Therefore, deburn-in compensation requires information of a long period of stress accumulation, and the accumulation process requires continuous updating of the deburn-in offset value T_{N}_OFS, so as to obtain correct compensation results.

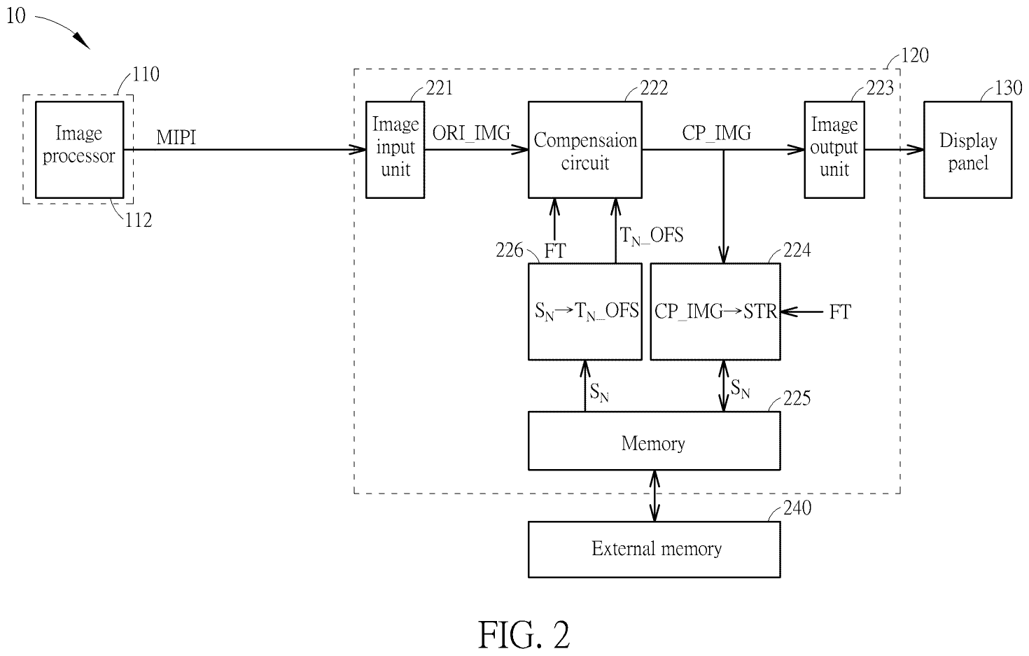

FIG. 2 illustrates a detailed implementation of handling deburn-in compensation through the DDIC 120 in the display system 10. As shown in FIG. 2, the DDIC 120 includes an image input unit 221, a compensation circuit 222 and an image output unit 223. In general, the AP 110 and the DDIC 120 may communicate through the mobile industry processor interface (MIPI). Therefore, the image input unit 221 may be or include a MIPI receiver, for receiving the original image data ORI_IMG from the AP 110. The compensation circuit 222 may include one or both of the deburn-in compensation circuit 122 and the demura compensation circuit 124, and may further include any other compensation circuits or modules to perform various image processing. In this embodiment, the compensation circuit 222 may perform compensation (including deburn-in compensation and/or demura compensation) on the original image data ORI_IMG to generate a compensated image data CP_IMG, which may be the deburn-in compensated image data T_{N}_IMG or the full-time compensated image data T₀+T_{N}_IMG shown in FIG. 1. The image output unit 223 may be or include an image output driver, for outputting data voltages corresponding to the compensated image data CP_IMG to drive the display operations of the display panel 130. After the DDIC 120 receives the original image data ORI_IMG from the AP 110, the compensation circuit 222 may be applied to compensate the original image data ORI_IMG, to generate the compensated image data CP_IMG to be output to the display panel 130.

In order to realize the deburn-in compensation, the DDIC 120 may further include a stress accumulator 224, a memory 225 and a stress-to-offset converter 226. The stress accumulator 224 may accumulate a stress value STR to generate an accumulated stress value S_{N}. The stress value STR is generated based on the image data to be displayed on the display panel 130, such as the compensated image data CP_IMG. As mentioned above, the burn-in comes from the result of long-term stress accumulation; hence, during the image output process, the stress accumulator 224 may be applied to convert the image data CP_IMG into the stress value STR and continue to accumulate. The accumulation result (as the accumulated stress value S_{N} at the time point N) may be stored in the memory 225. In an embodiment, the memory 225 may be a random access memory (RAM). Since the RAM is a volatile memory, the accumulated stress value S_{N} is preferably further written to and stored in an external memory 240, which may be a flash memory coupled to the DDIC 120. For each time point N, the accumulated stress value S_{N} represents the accumulated stress experienced by a certain pixel (or a certain block including multiple pixels) from the start of use of the display product to the present time point. A larger accumulated stress value S_{N} means that the pixel displays greater brightness in the long run, which may produce a deeper burn-in. In such a situation, a larger offset value is usually necessary to keep the consistency of the display image between pixels after compensation.

Therefore, when the compensation is required, the stress-to-offset converter 226 may retrieve the accumulated stress value S_{N} from the memory 225, and convert the accumulated stress value S_{N} into the deburn-in offset value T_{N}_OFS, allowing the compensation circuit 222 to use the deburn-in offset value T_{N}_OFS to perform compensation.

Since the images to be displayed on the display panel 130 may be affected by some operating factors, these operating factors need to be taken into account in the deburn-in compensation process. For example, as shown in FIG. 2, one or more operating factors FT are provided to the compensation circuit 222, to perform image data compensation according to the operating factors FT. The operating factors FT include brightness, frame rate, temperature, grayscale, etc., but not limited thereto. For example, in a mobile phone, the screen brightness may be adjusted according to the magnitude of the display brightness value (DBV), and the DBV may be adjusted according to the ambient light or different applications, or may be set by the user. Under the same grayscale value, if the DBV is larger, the brightness of the displayed image will be higher. Under different DBVs, the deburn-in offset value T_{N}_OFS required for the same grayscale value may be different. In general, under a high DBV, a slight grayscale change may produce a larger brightness difference. Therefore, in order to obtain the correct compensated image data CP_IMG, the corresponding deburn-in offset value T_{N}_OFS may be smaller. In addition, since the correspondence between the grayscale values and the display brightness is not linear but involves gamma conversion, the required deburn-in offset values T_{N}_OFS are also different under different grayscale levels. Further, the frame rate and temperature may also affect the magnitude of the deburn-in offset value T_{N}_OFS.

In addition, the accumulation of stress value STR would also be affected by various operating factors, which include the brightness, frame rate, and temperature, but not limited thereto. As shown in FIG. 2, one or more operating factors FT are also provided to the stress accumulator 224, to perform stress accumulation according to the operating factors FT. For example, the value of DBV may affect the brightness of the display panel 130, which directly affects the stress experienced by the pixels. Further, different frame rates mean that the pixels are applied with stresses at different times, and the light emitting devices (e.g., light emitting diodes (LEDs) or organic LEDs (OLEDs), etc.) in the pixels may also be subjected to different stresses under different temperatures.

In this embodiment, the stress accumulator 224 receives the compensated image data CP_IMG to be output instead of the original image data ORI_IMG to calculate the stress value STR. This is because the generation of burn-in is directly related to the actual brightness displayed on the display panel 130, and thus using the compensated image data CP_IMG to be output to the display panel 130 to calculate the stress value STR could achieve a more accurate compensation result. For example, if a pixel displays images with a higher brightness for a long time, this pixel may be subjected to a greater stress and would suffer a larger degree of brightness degradation, so that a larger offset value is required. According to the image data CP_IMG and the operating factors FT, the stress accumulator 224 may calculate the current accumulated stress value S_{N} by accumulating the previous accumulated stress value S_{N-1} with the obtained stress value STR.

In the structure of FIGS. 1-2, the deburn-in compensation, which is performed in the DDIC 120, may have many problems. Since the main purpose of the DDIC 120 is to drive the display panel 130, it needs to generate extremely high output voltages and thus uses a medium-level or low-level process (e.g., 28 or 40 nanometers). Its chip size is larger, and the memory space that could be deployed under the same circuit area is smaller, making it difficult to satisfy the needs of deburn-in compensation. As mentioned above, the deburn-in compensation needs to refer to the accumulation information of stress value STR over a long period of time. In addition, the number of pixels on the display panel 130 may be very large. Therefore, under the limited space of the memory 225 included in the DDIC 120, stress value accumulation and compensation have to be performed in a unit of a block having multiple merged pixels. For example, 8×8 pixels are combined into one block, to record an accumulated stress value S_{N} and calculate a deburn-in offset value T_{N}_OFS for the block. However, since a block may contain pixels with different degrees of burn-in, and neighboring pixels displaying the same color for a long time may have different offset values if they are assigned to different blocks, it is impossible to achieve an ideal compensation effect for each pixel, causing the output images to be blurry, especially at the edges of the blocks or text areas. In order to reduce the block size to improve the fineness of compensation, it is requested to make a tradeoff with the length of recording time.

In addition, due to the limitations of memory space, the data depth of the stress value that could be recorded is also limited. For example, the image data ORI_IMG or CP_IMG may be an 8-bit data with a grayscale value between 0 and 255. When converted into the stress value STR, only a 3-bit data may be recorded, i.e., the stress value STR between 0 and 7. For a white image having the maximum brightness, the calculated stress value STR may be equal to 7. In addition, as shown in FIG. 2, after the accumulated stress value S_{N} is calculated, in order to prevent the data in the memory 225 from being cleared when the DDIC 120 enters the sleep mode or becomes power-off, it is necessary to write the data of the accumulated stress value S_{N} into the external memory 240 for storage, and wait for the display system 10 to be woke up again and then read back the data. However, the external memory 240 is usually a flash memory, where the number of read/write times of the flash memory is limited, and frequent read/write operations will reduce the service life of the flash memory. Moreover, as shown in FIG. 1, the image data after deburn-in processing may first undergo demura processing and then be output to the display panel, so that the images actually displayed on the panel may be different from the deburn-in compensated image data T_{N}_IMG processed by the deburn-in compensation circuit 122; that is, the compensated image data CP_IMG shown in FIG. 2 might not be exactly identical to the final image data to be output to the display panel 130. As a result, the accumulated stress value S_{N} cannot accurately reflect the burn-in degree of the pixel. In general, the circuit designer of the DDIC 120 may place the more important processing circuit closer to the display panel 130. Since demura is usually more important than deburn-in, the image data may be designed to undergo deburn-in compensation first and then demura compensation, to achieve better compensation effects.

In order to solve the above problems, the present invention provides an image compensation method, which may move several compensation tasks less convenient to be handled by the DDIC to be performed in the AP. In an embodiment, all deburn-in operations may be performed through the AP.

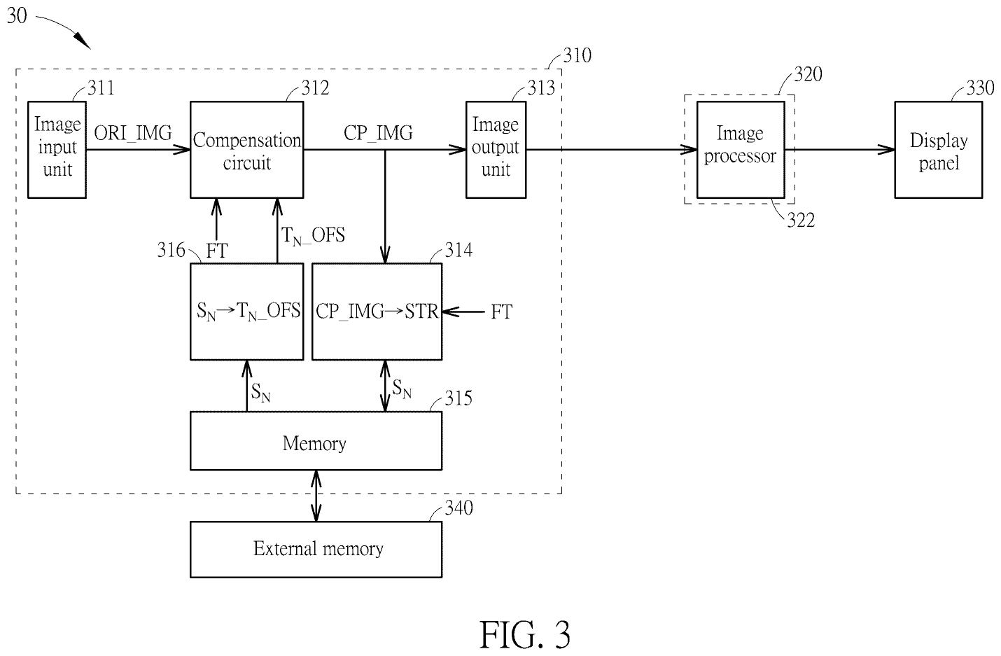

FIG. 3 is a schematic diagram of a display system 30 according to an embodiment of the present invention, where a detailed implementation of handling deburn-in compensation through the AP is shown. In detail, the display system 30 includes an AP 310, a DDIC 320 and a display panel 330. The operations of the AP 310, the DDIC 320 and the display panel 330 are similar to those of the AP 110, the DDIC 120 and the display panel 130 illustrated in the FIGS. 1-2, and will not be narrated herein.

As shown in FIG. 3, the AP 310 includes an image input unit 311, a compensation circuit 312, an image output unit 313, a stress accumulator 314, a memory 315 and a stress-to-offset converter 316, and may be coupled to an external memory 340. The operations of these circuits and modules are similar to the corresponding circuits and modules implemented in/with the DDIC 120 shown in FIG. 2, and will not be detailed herein. Different from the deburn-in operations of the display system 10, in the display system 30, the operations of calculation and storage of the accumulated stress value S_{N}, conversion of the deburn-in offset value T_{N}_OFS and related deburn-in compensation originally performed in the DDIC 120 are all instead performed in the AP 310, while the DDIC 320 may only perform other necessary image processing, such as demura, through an image processor 322. In general, demura only needs a record of the offset values at the initial time point (expressed as T₀_OFS), which may be stored in a memory (not illustrated) of the DDIC 320 with an appropriate compression method, and the memory space required is much smaller than the requirement of deburn-in compensation.

As mentioned above, since the DDIC is limited by the process and memory space, it is restricted to achieve an ideal compensation effect, and this problem may be solved with the assistance of the AP. In general, the AP may be the core processor of an electronic device. It usually applies the most advanced process (currently 3 to 4 nanometers) and could carry far larger memory space than the DDIC. In such a situation, the block size for deburn-in compensation may be reduced to improve the visual effect, or even the pixels do not need to be merged into blocks for deburn-in compensation; that is, each pixel (or subpixel) alone may have a recorded accumulated stress value and a calculated offset value, thereby solving the problem of blurry images after compensation. In addition, because the AP could store a larger amount of data, the time for stress value accumulation may be increased, and the data depth of stress values may also be increased, to obtain more accurate compensation results.

However, it should be noted that when deburn-in compensation is performed by the AP, there is still a problem that the images actually displayed on the display panel are different from the image data used for calculating and accumulating the stress value, causing the accumulated stress value cannot accurately reflect the burn-in degree of the pixel. In addition, the AP and the DDIC communicate through the MIPI interface, of which the image data bandwidth is generally 8 or 10 bit/channel, i.e., a resolution of 8 or 10 bits may be delivered for one subpixel; hence, the amount of data sent to the DDIC at most includes 10 bits per subpixel. The resolution of 8 or 10 bits may not achieve a satisfactory precision of image compensation. In comparison, the image processing performed in the DDIC may achieve an image data resolution of 12 bits or more, which is not limited to the bandwidth of the MIPI interface, allowing more detailed image variations.

In various embodiments of the present invention, the AP and the DDIC may coordinate in different ways to perform operations such as deburn-in calculation and compensation and demura compensation. Specifically, deburn-in may be selectively performed by the AP or the DDIC, demura may be selectively performed by the AP or the DDIC, and deburn-in and demura may be performed separately or cooperatively. Note that the calculation of stress values requires a large memory space to store long-term accumulation data of a large number of pixels; hence, the accumulation of stress values is preferably performed by the AP. Other operations related to deburn-in compensation and demura compensation may be performed by the AP or the DDIC according to system requirements, to form various methods of the present invention.

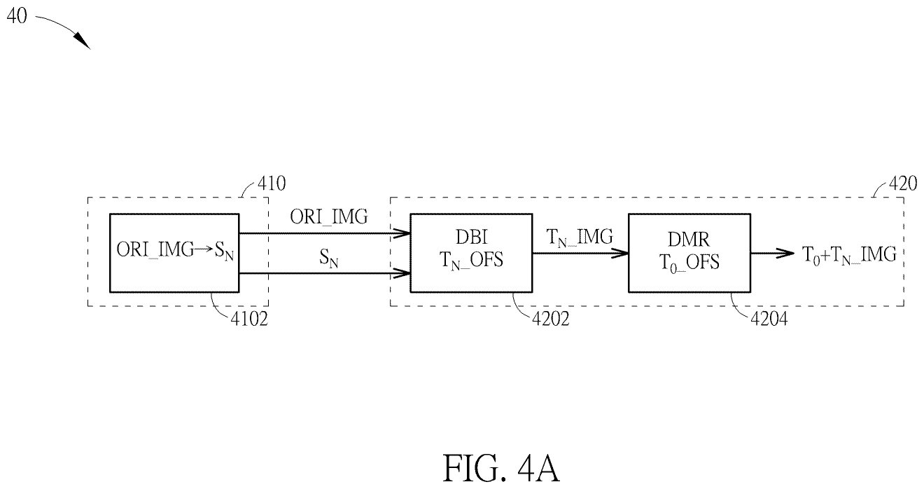

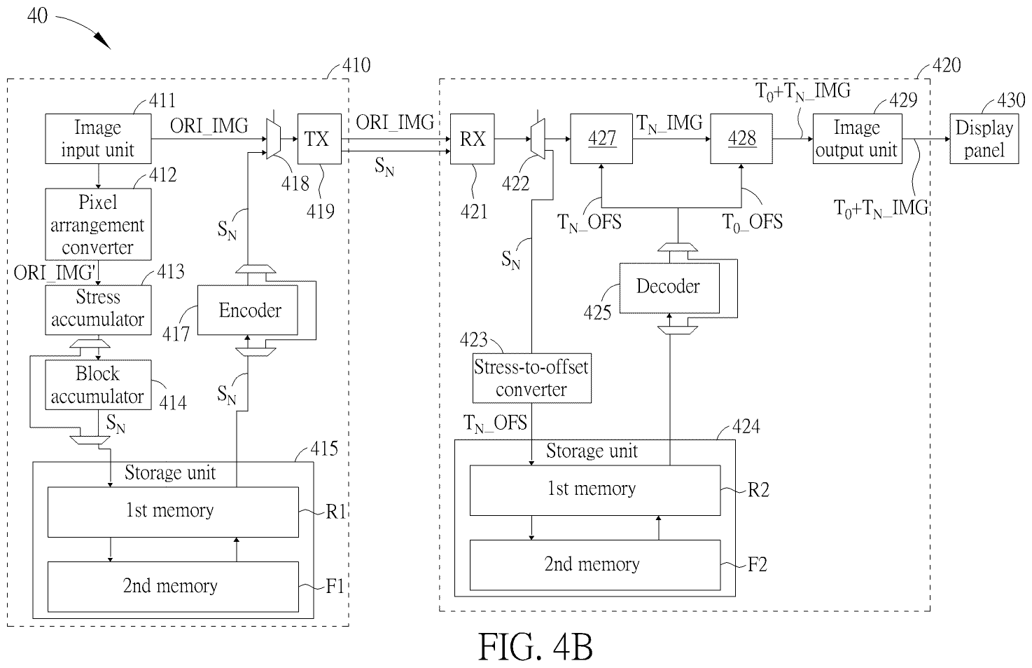

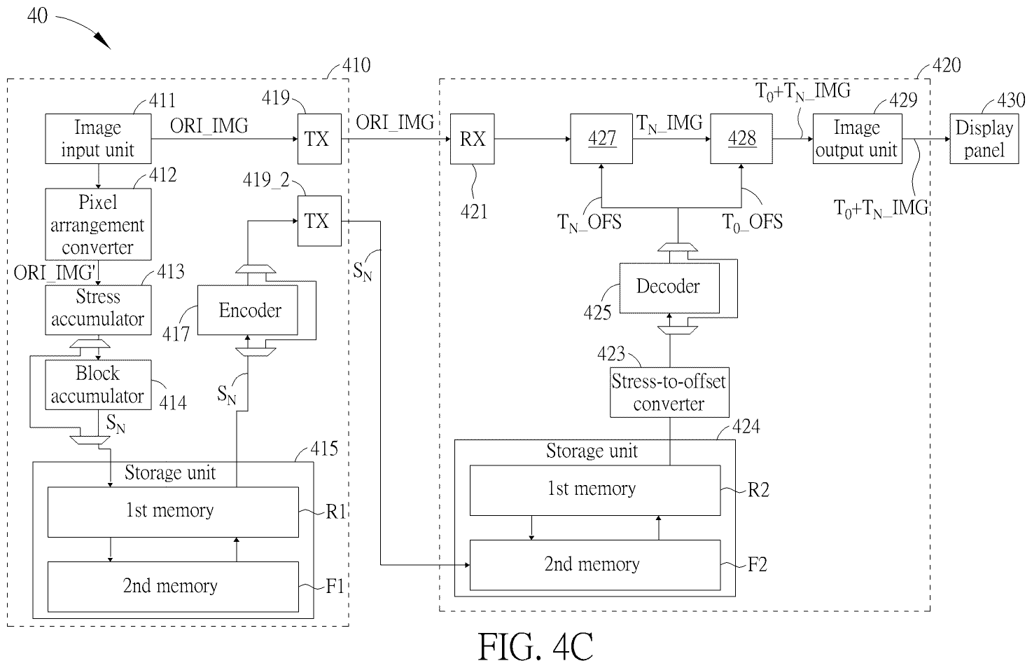

FIG. 4A is a schematic diagram of a display system 40 according to an embodiment of the present invention. The display system 40 includes an AP 410 and a DDIC 420, and a display panel may also be included but omitted in FIG. 4A for brevity. The AP 410 may include a processing module 4102 such as a stress accumulator, to perform the accumulation of stress values for deburn-in. The DDIC 420 may include a deburn-in (DBI) compensation circuit 4202 and a demura (DMR) compensation circuit 4204, to perform deburn-in compensation and demura compensation, respectively.

More specifically, after the processing module 4102 of the AP 410 performs stress value accumulation to generate an accumulated stress value S_{N}, the accumulated stress value S_{N} may be sent to the DDIC 420. The deburn-in compensation circuit 4202 of the DDIC 420 receives the accumulated stress value S_{N} and also receives the original image data ORI_IMG from the AP 410, to convert the accumulated stress value S_{N} into the corresponding deburn-in offset value T_{N}_OFS, which is used for performing deburn-in compensation on the original image data ORI_IMG. After the deburn-in compensation, the deburn-in compensation circuit 4202 may generate a deburn-in compensated image data T_{N}_IMG and send it to the demura compensation circuit 4204 to perform demura compensation with the demura offset value T₀_OFS. Finally, the full-time compensated image data T₀+T_{N}_IMG may be generated.

In this embodiment, the stress value accumulation operation is performed by the AP 410 rather than the DDIC 420. Taking advantage of the larger memory space of the AP 410, the time and data depth of stress value accumulation may be increased. Other operations related to deburn-in compensation and demura compensation are still handled by the DDIC 402, e.g., through the deburn-in compensation circuit 4202 and the demura compensation circuit 4204. Since the data sent by the AP 410 to the DDIC 420 only includes the original image data ORI_IMG and the information of the accumulated stress value S_{N}, where the resolution of the delivered image data would not be affected, the transmission may still be realized in the original MIPI interface.

FIG. 4B illustrates a detailed implementation of the display system 40. In addition to the AP 410 and the DDIC 420, the display system 40 further includes a display panel 430. The display panel 430 may be any type of panel, which may be an OLED panel or liquid crystal display (LCD) panel, but not limited thereto.

As shown in FIG. 4B, the AP 410 includes an image input unit 411, a pixel arrangement converter 412, a stress accumulator 413, a block accumulator 414, a storage unit 415, an encoder 417, a selector 418 and a transmitter (TX) 419. In this embodiment, the AP 410 is responsible for performing stress value accumulation and sending the accumulated stress value S_{N} to the DDIC 420. The AP 410 may also send the original image data ORI_IMG to the DDIC 420 for the display operations.

The image input unit 411 may include or may be coupled to an image generator, for generating or receiving the original image data ORI_IMG. The original image data ORI_IMG may be sent to the transmitter 419, to further be output to the DDIC 420; and may also be sent to the pixel arrangement converter 412 for the stress accumulation process.

The pixel arrangement converter 412, which is coupled between the image input unit 411 and the stress accumulator 413, may receive the original image data ORI_IMG and convert the original image data ORI_IMG into a pixel data ORI_IMG′ corresponding to the arrangement of pixels on the display panel 430 controlled by the DDIC 420. More specifically, the image data should be modified to be adapted to the pixel arrangement before the stress value accumulation, so that the accumulated stress value S_{N} may correspond to the pixel arrangement on the display panel 430. For example, most LCD or OLED panels on the market use the subpixel rendering (SPR) technology to reduce the number of subpixels on the display panel and increase the resolution of pixels. According to the SPR technology, the subpixel arrangement of the display panel is different from the traditional RGB (Red, Green, Blue), and each pixel contains a fewer number of subpixels, such as RG or BG. RG pixels and BG pixels are arranged alternately, and the missing blue or red information may be borrowed from neighboring pixels to achieve the same visual effects. Under the SPR technology, the original image data ORI_IMG output by the AP 410 need to be converted into the data corresponding to the pixel arrangement of the display panel 430 through the DDIC 420, and then are output to the corresponding pixels on the display panel 430. In such a situation, the burn-in degree of each subpixel on the display panel 430 will also correspond to its respective brightness and received data voltages. In order to obtain the correct offset value, the stress value accumulation in the AP 410 should also comply with the subpixel arrangement on the display panel 430. Therefore, the stress accumulator 413 is requested to perform stress value accumulation for the subpixels actually existing on the display panel 430. In such a situation, the pixel arrangement converter 412 of the AP 410 needs to know in advance the SPR arrangement used by the display panel 430, and converts to generate the pixel data ORI_IMG′ that corresponds to each subpixel. The subsequent stress value accumulation and offset value calculation for each subpixel (or each block) are then performed accordingly.

The stress accumulator 413 may generate a stress value STR according to the original image data ORI_IMG (which is converted into the form complying with the pixel arrangement in advance, as the pixel data ORI_IMG′). With reference to the abovementioned operating factors (such as brightness, grayscale, frame: rate and/or temperature), the stress value STR may be generated according to the actual brightness of the corresponding pixel (or subpixel).

The block accumulator 414, which is coupled to the stress accumulator 413, may perform stress value accumulation for each block. In order to save the usage of memory space, several pixels or subpixels may be merged to a block for performing stress value accumulation. The block accumulator 414 may serve this purpose.

In an embodiment, the stress accumulator 413 and the block accumulator 414 may cooperatively accumulate the stress value STR to generate the accumulated stress value S_{N} for each block. More specifically, the stress accumulator 413 and the block accumulator 414 may retrieve the accumulated stress value S_{N-1} at the previous time point from the storage unit 415. The present stress value STR converted from the pixel data ORI_IMG′ for each pixel in the block may be averaged and then added to the accumulated stress value S_{N-1} to generate a new accumulated stress value S_{N}, which is then sent to the storage unit 415 to be stored.

In another embodiment, it is preferable to perform stress value accumulation for each subpixel separately. In other words, each block may represent one pixel or subpixel. In such a situation, the stress accumulator 413 may accumulate stress value by taking a pixel or subpixel as a unit, where the block accumulator 414 may be bypassed, as shown in FIG. 4B. Note that the stress value accumulation is performed in the AP 410, which has far more memory space and larger power capacity than the DDIC 420. Even if the accumulated stress value for each subpixel is recorded individually, the required memory space and power consumption is still within the capacity of a general AP.

The storage unit 415 may include a first memory R1 and a second memory F1. The first memory R1 may be implemented in the AP 410, such as a RAM. The second memory F1 may be a nonvolatile memory built in the AP 410 or externally connected to the AP 410, such as a flash memory. The storage unit 415 may be used to store the accumulated stress value S_{N} for each block or subpixel. In an embodiment, during the process of stress value accumulation and calculation, the AP 410 may access the first memory R1 when performing the calculation. After the stress value accumulation is completed, the data associated with the updated accumulated stress value S_{N} may be written into the second memory F1 to be stored, to prevent the data in the first memory R1 from being deleted when the AP 410 enters the sleep mode, becomes power-off, or allocates the storage resource to another task.

Based on the storage capacity of the storage unit 415, the accumulated stress value S_{N} may be predetermined to have a specific data depth for each subpixel or block, e.g., 32, 24 or 16 bits, where a larger data depth may be used to store larger stress resolution and/or perform stress value accumulation for a longer time. For example, for one subpixel, the image data in each frame may generate a 3-bit stress value STR. This stress value STR may be accumulated continuously until it reaches 2³², 2²⁴ or 2¹⁶ (depending on the data depths of 32, 24 or 16 bits, respectively). Since the AP 410 is usually equipped with a considerable memory capacity (compared to the DDIC), it may allocate enough memory space in the storage unit 415 to store the accumulated stress values S_{N}. In an exemplary embodiment, if a data depth of 24 bits is applied and the stress value STR is recorded every 1.5 seconds, the usage time for accumulation may be 600 hours in the worst case (i.e., the stress value/brightness is maintained at the highest level). However, the display panel 430 may not continuously display the brightness image, and most of the time the display panel 430 may be off since the electronic product is not in use. Therefore, under normal use, the accumulation time would be much greater than 600 hours. In fact, since the AP 410 applies the most advanced process technology, allocating additional memory space to increase the data depth of stress value accumulation would not cause too much burden on the AP 410.

The encoder 417, which is coupled between the storage unit 415 and the transmitter 419, may compress the data of the accumulated stress value S_{N} before the accumulated stress value S_{N} is sent to the DDIC 420. The compression of the accumulated stress value S_{N} may reduce the data quantity that needs to be delivered through the MIPI interface, thereby reducing the power consumption of data transmission.

In another embodiment, in order to keep the data integrity of the accumulated stress value S_{N}, the accumulated stress value S_{N} may be sent to the transmitter 419 by bypassing the encoder 417, or the encoder 417 shown in FIG. 4B may be omitted. In such a situation, the AP 410 may send the accumulated stress value S_{N} without being compressed or encoded to the DDIC 420, and the operations of deburn-in compensation may not be affected.

The selector 418 may selectively output the original image data ORI_IMG or the accumulated stress value S_{N} at each time point. In this embodiment, the original image data ORI_IMG and the accumulated stress value S_{N} are output to the DDIC 420 through the same interface, and thus the selector 418 may be deployed to perform output setting. For example, the original image data ORI_IMG may be output in a display period, and the accumulated stress value S_{N} may be output in a non-display period, as could be controlled by the selector 418. In various embodiments, the selector 418 may be implemented by using a multiplexer, but not limited thereto.

The transmitter 419 may be an output circuit used to output the original image data ORI_IMG and the accumulated stress value S_{N} to the DDIC 420. In various embodiments, the AP 410 sends the image data and related compensation data through a MIPI interface, and thus the transmitter 419 may be a MIPI transmitter.

Please continue to refer to FIG. 4B. The DDIC 420 includes a receiver (RX) 421, a selector 422, a stress-to-offset converter 423, a storage unit 424, a decoder 425, a deburn-in compensation circuit 427, a demura compensation circuit 428 and an image output unit 429. The DDIC 420 is responsible for driving the display panel 430 to display by receiving image data (i.e., ORI_IMG) from the AP 410 through the MIPI interface. The DDIC 420 may also receive compensation data associated with deburn-in compensation from the AP 410 at appropriate time, such as the accumulated stress value S_{N}.

The receiver 421 may be a receiving circuit used to receive the original image data ORI_IMG and the accumulated stress value S_{N} from the AP 410. In various embodiments, the DDIC 420 receives the image data and related compensation data through a MIPI interface, and thus the receiver 421 may be a MIPI receiver.

The selector 422 may output the received original image data ORI_IMG and accumulated stress value S_{N} to the compensation circuits 427/428 or the stress-to-offset converter 423 selectively. More specifically, the accumulated stress value S_{N} should be delivered to the stress-to-offset converter 423 to be converted into a corresponding offset value. The original image data ORI_IMG should be delivered to the compensation circuits 427 and 428 for image compensation.

The stress-to-offset converter 423, which is coupled between the receiver 421 and the storage unit 424, may convert the accumulated stress value S_{N} into a deburn-in offset value T_{N}_OFS, and send the deburn-in offset value T_{N}_OFS to the storage unit 424 to be stored. Each deburn-in offset value T_{N}_OFS may be used for a subpixel or a block, depending on whether the accumulated stress value S_{N} is accumulated for a subpixel or a block.

The storage unit 424 may include a first memory R2 and a second memory F2. The first memory R2 may be implemented in the DDIC 420, such as a RAM. The second memory F2 may be a nonvolatile memory built in the DDIC 420 or externally connected to the DDIC 420, such as a flash memory. In this embodiment, since the storage unit 424 is coupled to the output terminal of the stress-to-offset converter 423, it may be used to store the deburn-in offset value T_{N}_OFS which is converted from the accumulated stress value S_{N}. In an embodiment, during the image processing, the DDIC 420 may access the first memory R2 to obtain the required offset values for compensation. After the accumulated stress value S_{N} for an image frame is completely received by the storage unit 424, the related data may be written into the second memory F2 to be stored, to prevent the data in the first memory R2 from being deleted when the DDIC 420 enters the sleep mode, becomes power-off, or allocates the storage resource to another task. Note that the second memory F2 is requested to store a great number of deburn-in offset values T_{N}_OFS in an entire frame. In a preferable embodiment, the second memory F2 is an external memory, and thus the area of the DDIC 420 may be saved.

The decoder 425, which is coupled between the storage unit 424 and the compensation circuits 427 and 428, may decompress the data of the deburn-in offset value T_{N}_OFS and/or the demura offset value T₀_OFS before these data are sent to the compensation circuit 427 or 428. The decoder 425 may apply an encoding scheme identical to that applied to the encoder 417 of the AP 410. Since the compensation data stored in the storage unit 424 have been compressed on the AP 410 side, they should be decompressed and restored by the decoder 425 before being used for deburn-in compensation. In this embodiment, since the stored compensation data is in a compressed form, the memory space and power consumption required by the storage operations may be saved.

In another embodiment, if the encoder 417 of the AP 410 is bypassed or omitted, the deburn-in offset value T_{N}_OFS stored in the storage unit 424 may also be read out by bypassing the decoder 425, or the decoder 425 shown in FIG. 4B may be omitted. In such a situation, the DDIC 420 may store the deburn-in offset value T_{N}_OFS without being compressed or encoded, and the operations of deburn-in compensation may not be affected.

The deburn-in compensation circuit 427, which is coupled to the storage unit 424 and the receiver 421, may read out the deburn-in offset value T_{N}_OFS (after decompressed) from the storage unit 424, and compensate the original image data ORI_IMG by using the deburn-in offset value T_{N}_OFS to generate a deburn-in compensated image data T_{N}_IMG.

Note that the storage unit 424 may also be used to store a demura offset value T₀_OFS in a compressed form or non-compressed form. The demura compensation circuit 428 may read out the demura offset value T₀_OFS from the storage unit 424, and compensate the deburn-in compensated image data T_{N}_IMG by using the demura offset value T₀_OFS to generate the full-time compensated image data T₀+T_{N}_IMG.

Subsequently, the image output unit 429 may output the data voltage corresponding to the full-time compensated image data T₀+T_{N}_IMG to the display panel 430, where the brightness inconsistencies between pixels that result from demura and deburn-in may be well compensated.

In a preferable embodiment, the demura offset value T₀_OFS and the deburn-in offset value T_{N}_OFS are both stored in a unit of one subpixel. Therefore, the compensation circuits 427 and 428 may perform compensation by using the most appropriate offset values for each subpixel, and the above shortcomings of blurred images at edges of blocks or text areas may be solved.

Note that the circuit structure shown in FIG. 4B is one of various implementations of the display system 40. In another embodiment, the AP 410 and the DDIC 420 may be operated in another manner. FIG. 4C illustrates another detailed implementation of the display system 40. The implementations and operations of the display system 40 shown in FIG. 4C are similar to those shown in FIG. 4B, so signals and elements having similar functions are denoted by the same symbols. Their main difference is that, in the display system 40 shown in FIG. 4C, the AP 410 may directly access the storage unit 424 of the DDIC 420.

In detail, as shown in FIG. 4C, the AP 410 includes an image input unit 411, a pixel arrangement converter 412, a stress accumulator 413, a block accumulator 414, a storage unit 415, an encoder 417, and transmitters (TX) 419 and 419_2. The transmitter 419 may be a MIPI transmitter as in the above embodiment, for sending the original image data ORI_IMG to the DDIC 420. The transmitter 419_2 may send the accumulated stress value S_{N} to the storage unit 424 of the DDIC 420 through another interface. In an embodiment, the AP 410 may access the storage unit 424 through a serial peripheral interface (SPI). Therefore, the transmitter 419_2 may be a SPI transmitter for sending the accumulated stress value S_{N} through the SPI.

Other circuits and modules included in the AP 410 shown in FIG. 4C are the same as those shown in FIG. 4B, and their operations will not be narrated herein.

Please continue to refer to FIG. 4C. The DDIC 420 includes a receiver (RX) 421, a stress-to-offset converter 423, a storage unit 424, a decoder 425, a deburn-in compensation circuit 427, a demura compensation circuit 428 and an image output unit 429. In this embodiment, since the AP 410 sends the accumulated stress value S_{N} to the storage unit 424 directly, the storage unit 424 may store the accumulated stress value S_{N} instead of the deburn-in offset value T_{N}_OFS. Correspondingly, the stress-to-offset converter 423 should be coupled between the storage unit 424 and the compensation circuits 427 and 428. Therefore, the stress-to-offset converter 423 may read out the accumulated stress value S_{N} from the storage unit 424 and convert the accumulated stress value S_{N} into the deburn-in offset value T_{N}_OFS, and then send the deburn-in offset value T_{N}_OFS to the deburn-in compensation circuit 427 for deburn-in compensation.

In addition, the storage unit 424 may further be used to store the demura offset value T₀_OFS. Note that the demura offset value T₀_OFS is a known value generated when the display system 40 is put into use, and it does not need the accumulation operation. Therefore, in the demura compensation process, the demura compensation circuit 428 may read out the demura offset value T₀_OFS from the storage unit 424.

Since the accumulated stress value S_{N} is provided from the AP 410 through the SPI, the receiver 421 of the DDIC 420 only needs to receive the image data (i.e., ORI_IMG). In other words, the DDIC 420 receives the accumulated stress value S_{N} from the AP 410 without through the receiver 421.

Other circuits and modules included in the DDIC 420 shown in FIG. 4C are the same as those shown in FIG. 4B, and their operations will not be narrated herein.

In the display system 40, the DDIC 420 is still responsible for performing the deburn-in compensation and demura compensation, while the stress value accumulation that requires a larger memory space and more power consumption is performed by the AP 410. In such a situation, the overall performance of the display system 40 may be improved by taking advantage of the powerful operation capability and storage capacity of the AP 410. In other embodiments described below, there may be more compensation tasks performed by the AP.

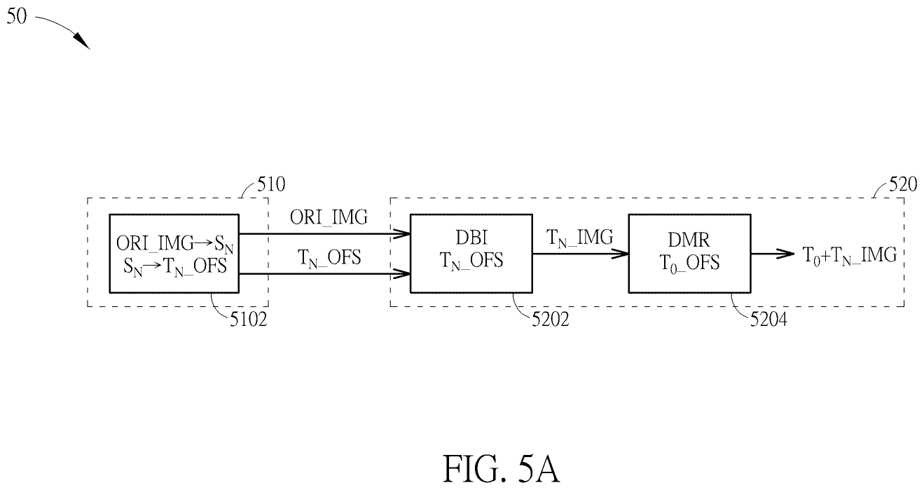

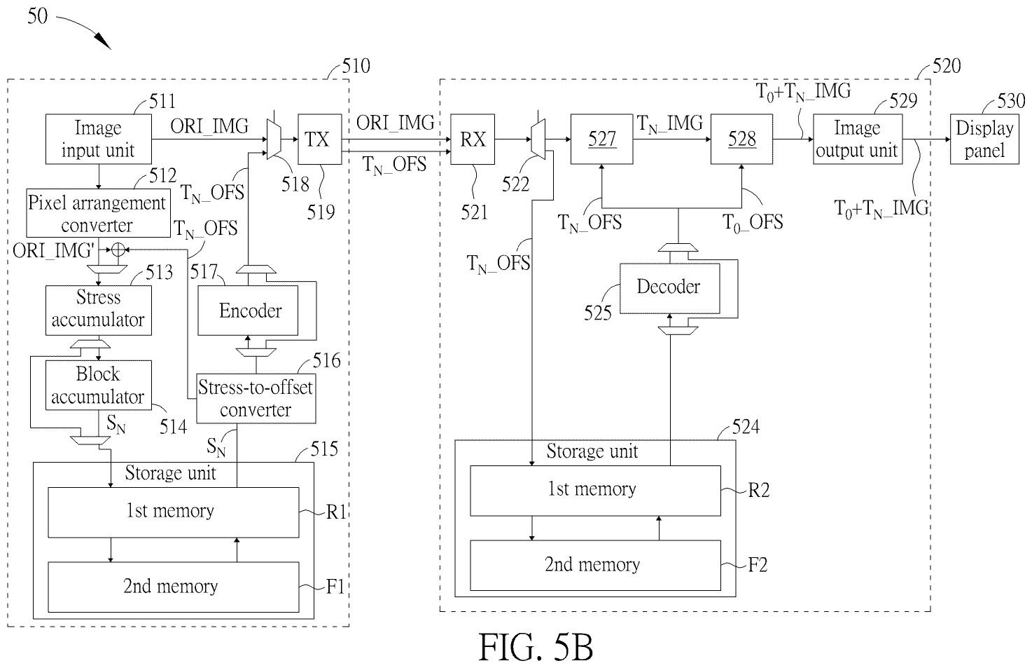

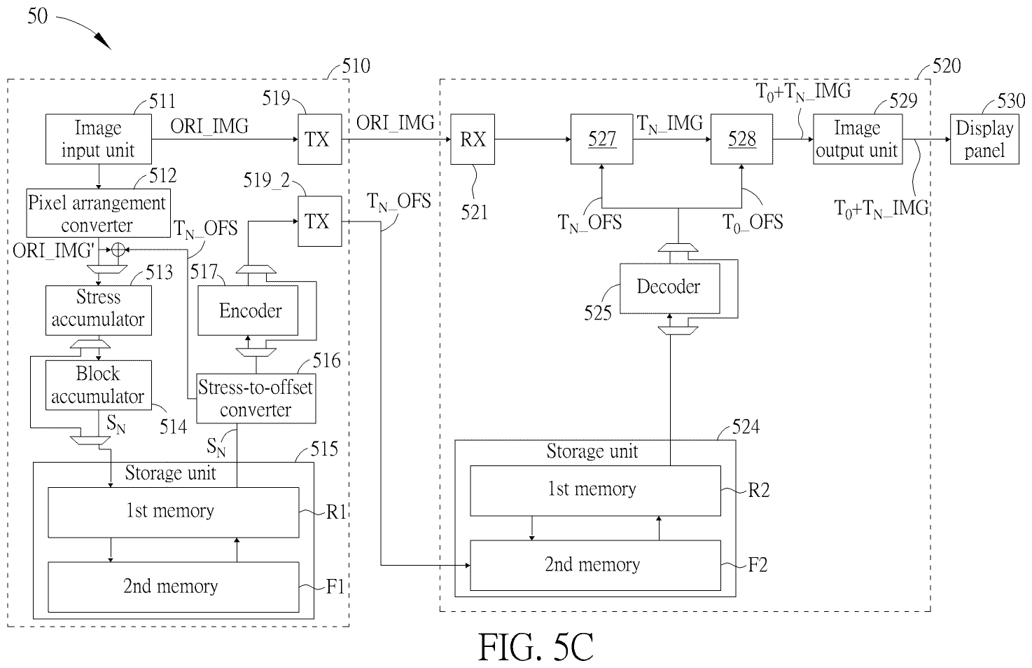

FIG. 5A is a schematic diagram of another display system 50 according to an embodiment of the present invention. The display system 50 includes an AP 510 and a DDIC 520, and a display panel may also be included but omitted in FIG. 5A for brevity. The AP 510 may include a processing module 5102, which may perform the accumulation of stress values for deburn-in, and also perform conversion to generate a deburn-in offset value T_{N}_OFS. The DDIC 520 may include a deburn-in (DBI) compensation circuit 5202 and a demura (DMR) compensation circuit 5204, to perform deburn-in compensation and demura compensation, respectively.

More specifically, after the AP 510 accumulates the stress value STR to generate the accumulated stress value S_{N}, it may further convert the accumulated stress value S_{N} into the deburn-in offset value T_{N}_OFS. The AP 510 then sends the information of the deburn-in offset value T_{N}_OFS to the DDIC 520. The deburn-in compensation circuit 5202 in the DDIC 520 may receive the deburn-in offset value T_{N}_OFS and also receive the original image data ORI_IMG from the AP 510, to perform deburn-in compensation on the original image data ORI_IMG by using the deburn-in offset value T_{N}_OFS. Subsequently, the deburn-in compensated image data T_{N}_IMG is then sent to the demura compensation circuit 5204 to perform demura compensation with the demura offset value T₀_OFS. Finally, the full-time compensated image data T₀+T_{N}_IMG may be generated.

In this embodiment, the AP 510 is responsible for the accumulation of stress value and the calculation of deburn-in offset value T_{N}_OFS. Therefore, the compensation data sent from the AP 510 to the DDIC 520 may be the deburn-in offset value T_{N}_OFS instead of the accumulated stress value S_{N}. The deburn-in offset value T_{N}_OFS may also be easily delivered through the MIPI interface without affecting the transmission of the image data.

FIG. 5B illustrates a detailed implementation of the display system 50. In addition to the AP 510 and the DDIC 520, the display system 50 further includes a display panel 530. Similarly, the display panel 530 may be any type of panel, which may be an OLED panel or LCD panel, but not limited thereto.

As shown in FIG. 5B, the AP 510 includes an image input unit 511, a pixel arrangement converter 512, a stress accumulator 513, a block accumulator 514, a storage unit 515, a stress-to-offset converter 516, an encoder 517, a selector 518 and a transmitter (TX) 519. In this embodiment, the AP 510 may perform stress value accumulation to generate the accumulated stress value S_{N}, and perform offset value conversion to generate the deburn-in offset value T_{N}_OFS. The AP 510 may send the deburn-in offset value T_{N}_OFS and also send the original image data ORI_IMG to the DDIC 520.

The detailed operations of various circuits and modules included in the AP 510 are similar to those in the AP 410, and will not be narrated herein. The difference between the AP 510 and the AP 410 is that the AP 510 further includes a stress-to-offset converter 516. In other words, the stress-to-offset converter, which is used for converting the accumulated stress value S_{N} into the deburn-in offset value T_{N}_OFS, is implemented in the AP 510 instead of the DDIC 520. As shown in FIG. 5B, the stress-to-offset converter 516 may read out the accumulated stress value S_{N} from the storage unit 515, convert the accumulated stress value S_{N} into the deburn-in offset value T_{N}_OFS, and send the deburn-in offset value T_{N}_OFS to the encoder 517 or the transmitter 519.

Another difference between the AP 510 and the AP 410 is that the stress value accumulation may be performed with reference to the compensated image data in the AP 510. Note that in the AP 410, the stress value STR is converted from the original image data ORI_IMG, which may be different from the image data actually output to the display panel 430, and thus the stress value STR cannot entirely reflect the burn-in experienced by the corresponding pixel. Therefore, in the AP 510, the stress value STR may be generated according to the original image data ORI_IMG along with the deburn-in offset value T_{N}_OFS, so that the image data for stress value accumulation may be closer to the image data actually output to the display panel 530. For example, in the embodiment as shown in FIG. 5B, the stress accumulator 513 may further receive the deburn-in offset value T_{N}_OFS generated by the stress-to-offset converter 516, and thereby generate the stress value STR according to the compensated image data which is generated from the original image data ORI_IMG compensated by the deburn-in offset value T_{N}_OFS.

Please continue to refer to FIG. 5B. The DDIC 520 includes a receiver (RX) 521, a selector 522, a storage unit 524, a decoder 525, a deburn-in compensation circuit 527, a demura compensation circuit 528 and an image output unit 529. The DDIC 520 may receive the original image data ORI_IMG and also receive the deburn-in offset value T_{N}_OFS from the AP 510 through the MIPI interface, to compensate the original image data ORI_IMG by using the deburn-in offset value T_{N}_OFS (and also using the demura offset value T₀_OFS that stored in the storage unit 524 of the DDIC 520).

The detailed operations of various circuits and modules included in the DDIC 520 are similar to those in the DDIC 420, and will not be narrated herein. The difference between the DDIC 520 and the DDIC 420 is that there is no stress-to-offset converter included in the DDIC 520. Since the DDIC 520 may directly receive the deburn-in offset value T_{N}_OFS from the AP 510, it would not need to have the stress-to-offset converter. The received deburn-in offset value T_{N}_OFS may be written into the storage unit 524 to be stored, and then read out by the deburn-in compensation circuit 527 when deburn-in compensation is performed.

Note that the circuit structure shown in FIG. 5B is one of various implementations of the display system 50. In another embodiment, the AP 510 and the DDIC 520 may be operated in another manner. FIG. 5C illustrates another detailed implementation of the display system 50. The implementations and operations of the display system 50 shown in FIG. 5C are similar to those shown in FIG. 5B, so signals and elements having similar functions are denoted by the same symbols. Their main difference is that, in the display system 50 shown in FIG. 5C, the AP 510 may directly access the storage unit 524 of the DDIC 520.

More specifically, the AP 510 may access the storage unit 524 through another interface such as the SPI, and use another transmitter (TX) 519_2 to output the deburn-in offset value T_{N}_OFS to the DDIC 520. The detailed operations are similar to those illustrated in FIG. 4C, which are described in the above paragraphs and will not be repeated herein.

In the above embodiments shown in FIGS. 4A-4C and 5A-5C, the DDIC does not need to accumulate the stress value by itself, but receives the information of the accumulated stress value or the corresponding deburn-in offset value from the AP. Therefore, the DDIC only needs to update the value stored in the memory when receiving the accumulated stress value or deburn-in offset value. This significantly reduces the required power consumption and storage space in the DDIC, thereby improving the overall performance of the display system.

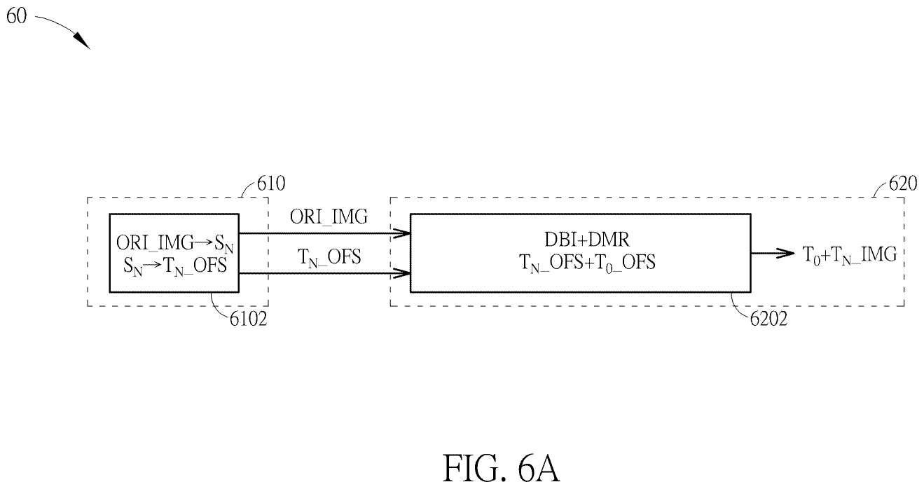

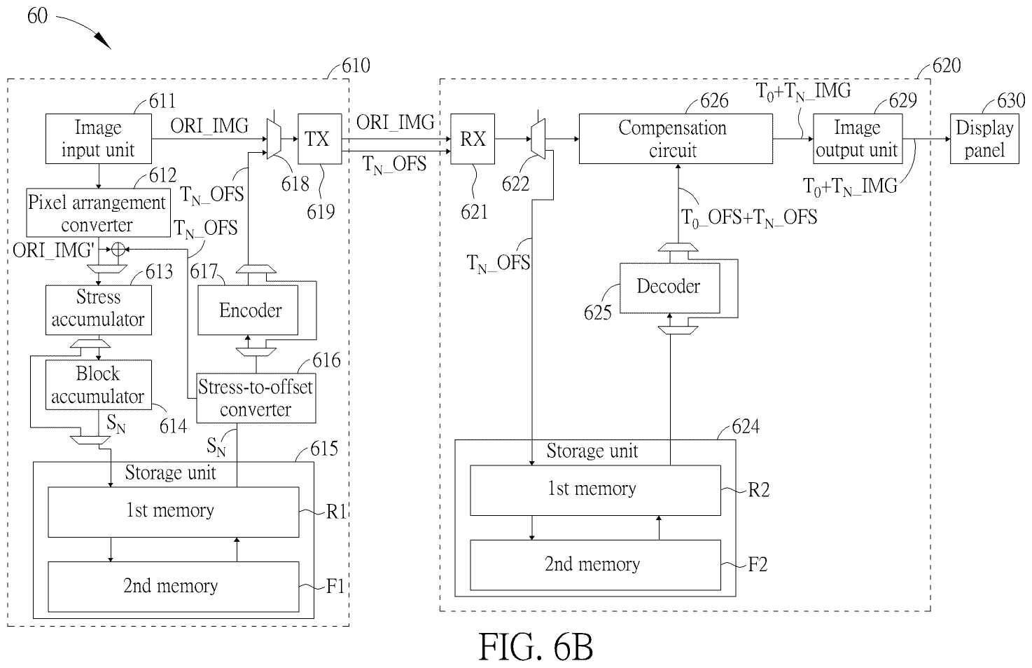

FIG. 6A is a schematic diagram of another display system 60 according to an embodiment of the present invention. The display system 60 includes an AP 610 and a DDIC 620, and a display panel may also be included but omitted in FIG. 6A for brevity. The AP 610 may include a processing module 6102, which may perform the accumulation of stress values for deburn-in, and also perform conversion to generate a deburn-in offset value T_{N}_OFS. The DDIC 620 may include a compensation circuit 6202 capable of performing deburn-in compensation (DBI) and demura compensation (DMR).

More specifically, after the AP 610 accumulates the stress value STR to generate the accumulated stress value S_{N}, it may further convert the accumulated stress value S_{N} into the deburn-in offset value T_{N}_OFS. The AP 610 then sends the information of the deburn-in offset value T_{N}_OFS to the DDIC 620, and also sends the original image data ORI_IMG to the DDIC 620. In the DDIC 620, deburn-in compensation and demura compensation functions are integrated in the compensation circuit 6202. The compensation circuit 6202 may combine the deburn-in offset value T_{N}_OFS and the demura compensation T₀_OFS to perform compensation on the original image data ORI_IMG, to generate the full-time compensated image data T₀+T_{N}_IMG. In an embodiment, the deburn-in compensation may be set as an additional compensation node of the demura compensation, to calculate the offset value in combination with the original compensation nodes.

FIG. 6B illustrates a detailed implementation of the display system 60. In addition to the AP 610 and the DDIC 620, the display system 60 further includes a display panel 630. Similarly, the display panel 630 may be any type of panel, which may be an OLED panel or LCD panel, but not limited thereto.

As shown in FIG. 6B, the AP 610 includes an image input unit 611, a pixel arrangement converter 612, a stress accumulator 613, a block accumulator 614, a storage unit 615, a stress-to-offset converter 616, an encoder 617, a selector 618 and a transmitter (TX) 619. Note that the structure of the AP 610 is identical to the structure of the AP 510, and the detailed operations of various circuits and modules included in the AP 610 are similar to those in the AP 510, which will not be repeated herein.

The DDIC 620 includes a receiver (RX) 621, a selector 622, a storage unit 624, a decoder 625, a compensation circuit 626 and an image output unit 629. The detailed operations of various circuits and modules included in the DDIC 620 are similar to those in the DDIC 520, and will not be narrated herein. The difference between the DDIC 620 and the DDIC 520 is that the DDIC 620 has only one compensation circuit 626, which may be an implementation of the compensation circuit 6202 shown in FIG. 6A.

As shown in FIG. 6B, the compensation circuit 626 may receive the original image data ORI_IMG from the AP 610 (through the receiver 621 and the selector 622. When image compensation needs to be performed, the compensation circuit 626 may read out the demura offset value T₀_OFS and the deburn-in offset value T_{N}_OFS from the storage unit 624. The demura offset value T₀_OFS and the deburn-in offset value T_{N}_OFS may be combined to perform image compensation.

As mentioned above, the burn-in comes from the result of long-term stress accumulation, rather than that the image content of each frame immediately generates burn-in on the next frame, and the short-term variations of burn-in cannot be observed by human eyes. Therefore, the stress value or offset value that the AP needs to send to the DDIC does not need to be sent at the same time with the image data, and the DDIC does not need to update the stored offset value information for each frame of image data. In a preferable embodiment, the AP may send the information of the stress value and/or offset value to the DDIC when the display device is in the sleep mode, to avoid affecting or occupying the bandwidth of image data transmission. Or the DDIC decides the update time and notifies the AP to send the updated content. For example, the AP of a mobile phone may detect that the screen is off and the mobile phone is in the sleep mode, and send the compensation data to the DDIC in the background process. Since the MIPI forwards the compensation data in the sleep mode without display operations, the delivery of the compensation data would not affect the transmission of the image data, and the transmitted compensation data amount and transmission speed would not be limited to the bandwidth of the MIPI interface.

Due to the long-term nature of the burn-in phenomenon, the display system may be configured to update the information of the stress value and/or offset value stored in the DDIC once every one or several days. Because the image content covers one or several days, there may be a leap in the update of the offset value. In order to have more subtle changes that are not visible to human eyes, an additional small storage space may be placed in the DDIC for storing the short-term (e.g., one or few days or hours) stress or offset content, which along with the general stress value or offset value sent from the AP may be converted into a finer offset value. When the storage space of the DDIC is almost exhausted, it may notify the AP to clear the DDIC storage space and re-accumulate again, and the DDIC may restart to update the stress value and/or offset value sent from the AP.

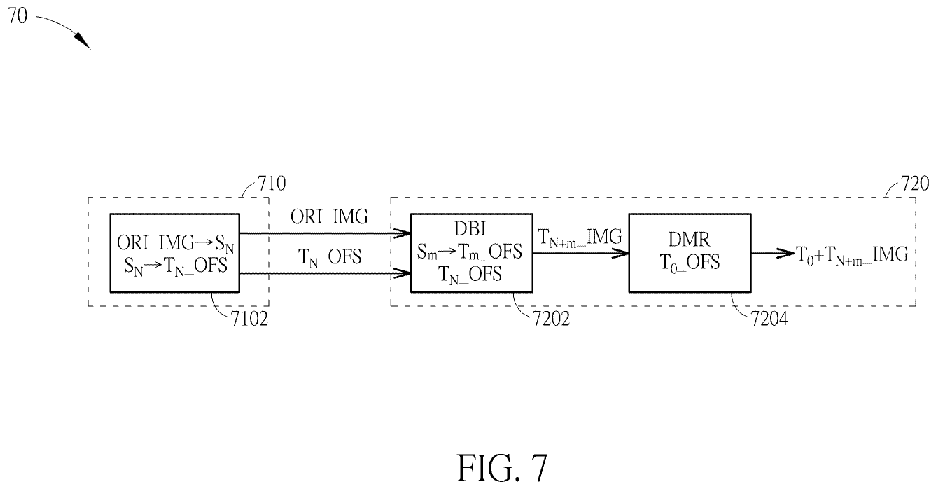

FIG. 7 is a schematic diagram of a display system 70 according to an embodiment of the present invention, where the display system 70 is an implementation of incorporating a finer offset value in the DDIC. In detail, the display system 70 includes an AP 710 and a DDIC 720, and a display panel may also be included but omitted in FIG. 7 for brevity. The AP 710 may include a processing module 7102, which may perform the accumulation of stress values for deburn-in, and also perform conversion to generate a deburn-in offset value T_{N}_OFS. The DDIC 720 may include a deburn-in (DBI) compensation circuit 7202 and a demura (DMR) compensation circuit 7204, to perform deburn-in compensation and demura compensation, respectively.

More specifically, after the AP 710 accumulates the stress value STR to generate the accumulated stress value S_{N}, it may further convert the accumulated stress value S_{N} into the deburn-in offset value T_{N}_OFS. The AP 710 then sends the information of the deburn-in offset value T_{N}_OFS to the DDIC 720. The deburn-in compensation circuit 7202 in the DDIC 720 may receive the deburn-in offset value T_{N}_OFS as a main offset value, and also receive the original image data ORI_IMG from the AP 710. In addition, the deburn-in compensation circuit 7202 may perform accumulation of stress value to generate an auxiliary accumulated stress value Sₘ, which may further be converted into an auxiliary offset value Tₘ_OFS. Therefore, the deburn-in compensation circuit 7202 may compensate the original image data ORI_IMG by using the main offset value T_{N}_OFS and the auxiliary offset value Tₘ_OFS, to obtain a deburn-in compensated image data T_{N+m}_IMG. Subsequently, the deburn-in compensated image data T_{N+m}_IMG is sent to the demura compensation circuit 7204, which performs demura compensation to generate the full-time compensated image data T₀+T_{N+m}_IMG.

In this embodiment, a storage space is further set up in the DDIC 720 to record the auxiliary accumulated stress value Sₘ, which is used for providing finer changes in the offset value, to improve the compensation effect during the period when the AP 710 does not update the offset value. For example, if the update unit N of the AP 710 outputting the deburn-in offset value T_{N}_OFS is one day, the parameter m of the auxiliary accumulated stress value Sₘ may be predetermined to represent the hour (the range of the value m may be from 0 to 23). If (N, m) is (5, 3), it means the 3^{rd} hour on the 5^{th} day. At the start of the (N+1)^{th} day, m will return to 0 and restart to accumulate. Alternatively, if the update unit N of the AP 710 outputting the deburn-in offset value T_{N}_OFS is 5 days, then m may be the 1^{st} to 4^{th} day of every 5 days, and the range of its value may be, for example, between 0 and 4. In such a situation, if (N, m) is (5, 3), it means 3 days after the 5^{th} day. On the (N+5)^{th} day, m will return to 0 and restart to accumulate. In another embodiment, the deburn-in compensation circuit 7202 that provides the auxiliary stress value information may also be integrated with the demura compensation circuit 7204, as the above implementation shown in FIG. 6A.

Another implementation is as follows, where the DDIC may use an existing storage unit for storing various offset values for compensation. The deburn-in offset value or accumulated stress value is scheduled to be updated once every one or several days, but during the period without scheduled updating, a small auxiliary offset value or stress value may be updated or replaced. The updated values may be received from the AP. Because the updated value is small, it may have a higher update frequency to make the compensated images finer. For example, if a deburn-in offset value has 8 bits, the 5 most significant bits (MSBs) may be updated once a day, and the 3 least significant bits (LSBs) may be updated every hour. In addition, if the value to be updated exceeds the expected capacity, the DDIC may immediately notify the AP to send the updated data without waiting for one day or several days.

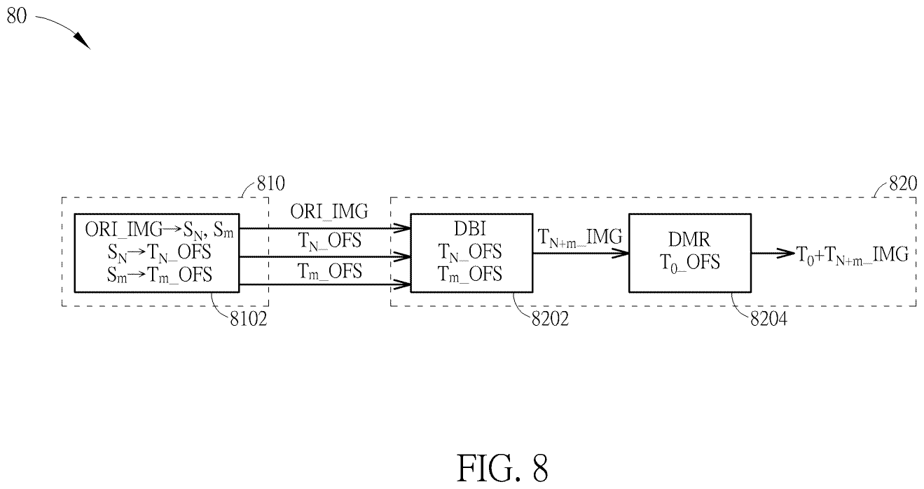

A relevant implementation is shown in FIG. 8, which is a schematic diagram of a display system 80. The display system 80 includes an AP 810 and a DDIC 820, and a display panel may also be included but omitted in FIG. 8 for brevity. The AP 810 may include a processing module 8102, which may perform the accumulation of stress values for deburn-in to generate an accumulated stress value S_{N} and an auxiliary accumulated stress value Sₘ, and also perform conversion to generate a deburn-in offset value T_{N}_OFS (also called main offset value) and an auxiliary offset value Tₘ_OFS. The AP 810 may periodically send the main offset value T_{N}_OFS to the DDIC 820, and also send the auxiliary offset value Tₘ_OFS through a faster update frequency (or according to the request of the DDIC 820). More specifically, the AP 810 may send the main offset value T_{N}_OFS in a first frequency, and send the auxiliary offset value Tₘ_OFS in a second frequency greater than the first frequency. In an exemplary embodiment, the first frequency may correspond to an update unit of time equal to one day, and the second frequency may correspond to an update unit of time equal to one hour.

After receiving the main offset value T_{N}_OFS and the auxiliary offset value Tₘ_OFS, the deburn-in (DBI) compensation circuit 8202 in the DDIC 820 may combine the main offset value T_{N}_OFS and the auxiliary offset value Tₘ_OFS to perform deburn-in compensation to generate a deburn-in compensated image data T_{N+m}_IMG. The demura (DMR) compensation circuit 8204 then performs demura compensation by using the demura offset value T₀_IMG, to generate a full-time compensated image data T₀+T_{N+m}_IMG.

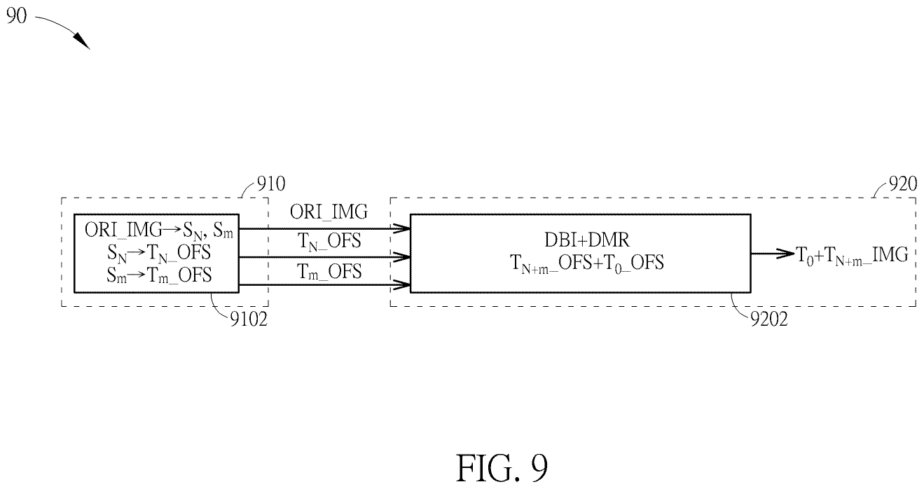

Similarly, in another embodiment, the implementation of the display system 80 may be modified to integrate the deburn-in compensation with the demura compensation, as the structure shown in FIG. 9. The display system 90 includes an AP 910 and a DDIC 920. The AP 910 includes a processing module 9102 for performing the accumulation of stress values and conversion to generate the main offset value T_{N}_OFS and the auxiliary offset value Tₘ_OFS. The DDIC 920 includes a compensation circuit 9202 capable of deburn-in compensation (DBI) and demura compensation (DMR) functions. The detailed operations are described in the above paragraphs, and will not be narrated herein.

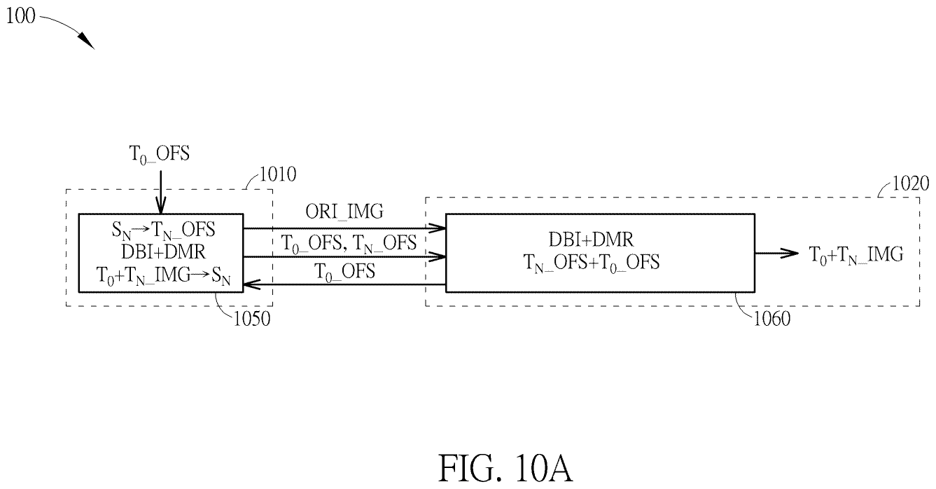

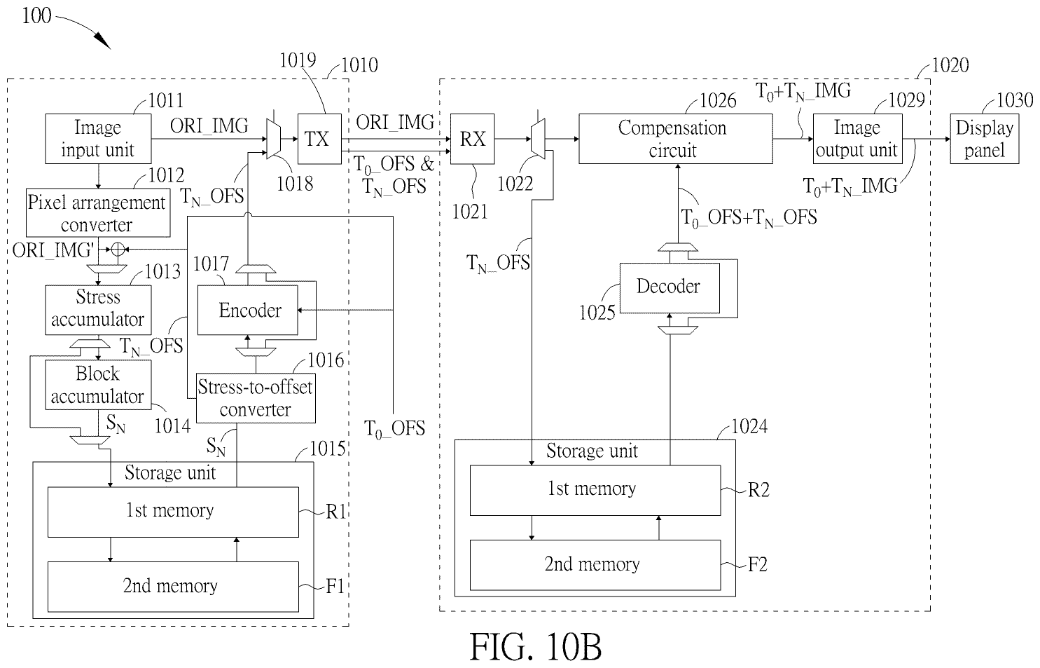

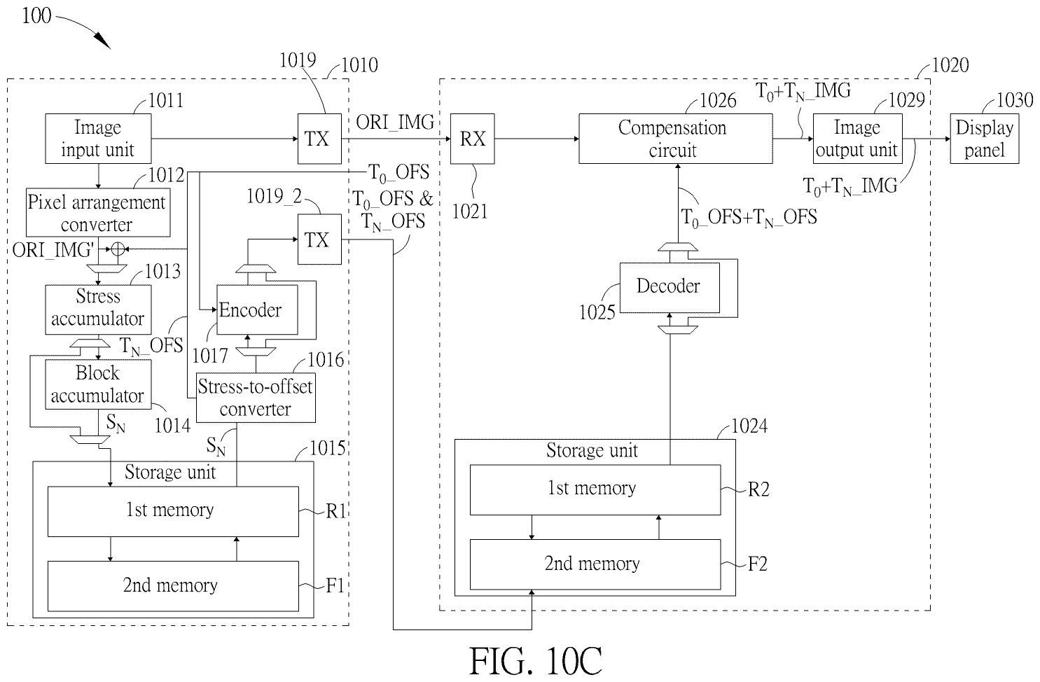

FIG. 10A is a schematic diagram of another display system 100 according to an embodiment of the present invention. The display system 100 includes an AP 1010 and a DDIC 1020. The AP 1010 includes a processing module 1050 for performing the accumulation of stress values and performing conversion to generate the main offset value T_{N}_OFS, which is sent to the DDIC 1020. In addition, the processing module 1050 may further perform deburn-in compensation and demura compensation. According to the information of the deburn-in offset value T_{N}_OFS and the demura offset value T₀_OFS (which may be obtained by taking a picture of the display panel or reading back the value from the DDIC 1020), the processing module 1050 may calculate the full-time compensated image data T₀+T_{N}_IMG and use it to accumulate the stress value STR and generate the accumulated stress value S_{N}.

Compared with the original image data ORI_IMG or the deburn-in compensated image data T_{N}_IMG, the full-time compensated image data T₀+T_{N}_IMG is closer to (or the same as) the image data actually sent to the display panel by the DDIC 1020, and therefore could reflect the burn-in degree experienced by the pixel more accurately and could be used to generate a more accurate compensation result. In addition, in this embodiment, the deburn-in compensation circuit is integrated with the demura compensation circuit in the DDIC 1020. The compensation circuit 1060 may receive the information of the deburn-in offset value T_{N}_OFS and also receive the original image data ORI_IMG from the AP 1010, and combine the deburn-in offset value T_{N}_OFS with the demura offset value T₀_OFS to perform compensation on the original image data ORI_IMG. The demura offset value T₀_OFS may be pre-stored in the DDIC 1020 before the demura compensation. In an embodiment, the demura offset value T₀_OFS may be provided from the AP 1010, as shown in FIG. 10A. Finally, the full-time compensated image data T₀+T_{N}_IMG may be generated.

FIG. 10B illustrates a detailed implementation of the display system 100. In addition to the AP 1010 and the DDIC 1020, the display system 100 further includes a display panel 1030. Similarly, the display panel 1030 may be any type of panel, which may be an OLED panel or LCD panel, but not limited thereto.

As shown in FIG. 10B, the AP 1010 includes an image input unit 1011, a pixel arrangement converter 1012, a stress accumulator 1013, a block accumulator 1014, a storage unit 1015, a stress-to-offset converter 1016, an encoder 1017, a selector 1018 and a transmitter (TX) 1019. Note that the structure of the AP 1010 is identical to the structure of the AP 510 or 610, and the detailed operations of various circuits and modules included in the AP 1010 are similar to those in the AP 510 or 610, which will not be repeated herein.

The difference between the AP 1010 and the AP 510 or 610 is that the AP 1010 further receives the information of the demura offset value T₀_OFS. More specifically, the stress accumulator 1013 of the AP 1010 may further receive the demura offset value T₀_OFS, and generate the stress value STR according to the compensated image data which is generated from the original image data ORI_IMG compensated by the demura offset value T₀_OFS. In this embodiment, the stress accumulator 1013 may compensate the original image data ORI_IMG by using both the demura offset value T₀_OFS and the deburn-in offset value T_{N}_OFS to generate the full-time compensated image data T₀+T_{N}_IMG, which may be used to perform stress value accumulation, to achieve a more accurate deburn-in compensation result.

The AP 1010 may obtain the demura offset value T₀_OFS in any manner. In an embodiment, the demura offset value T₀_OFS may be stored in an external memory, and is accessed by the AP 1010 when the AP 1010 needs to perform stress value accumulation. Alternatively, the demura offset value T₀_OFS may be stored in the storage unit 1024 of the DDIC 1020, and the AP 1010 may receive the demura offset value T₀_OFS from the DDIC 1020 through the MIPI or SPI interface.

The DDIC 1020 includes a receiver (RX) 1021, a selector 1022, a storage unit 1024, a decoder 1025, a compensation circuit 1026 and an image output unit 1029. The detailed operations of various circuits and modules included in the DDIC 1020 are similar to those in the DDIC 620, and will not be narrated herein.

FIG. 10C illustrates another detailed implementation of the display system 100. The implementations and operations of the display system 100 shown in FIG. 10C are similar to those shown in FIG. 10B, so signals and elements having similar functions are denoted by the same symbols. Their main difference is that, in the display system 100 shown in FIG. 10C, the AP 1010 may directly access the storage unit 1024 of the DDIC 1020.

More specifically, the AP 1010 may access the storage unit 1024 through another interface such as the SPI, and use another transmitter (TX) 1019_2 to send the deburn-in offset value T_{N}_OFS and the demura offset value T₀_OFS to the DDIC 1020. The detailed operations are similar to those illustrated in FIG. 4C, which are described in the above paragraphs and will not be repeated herein.

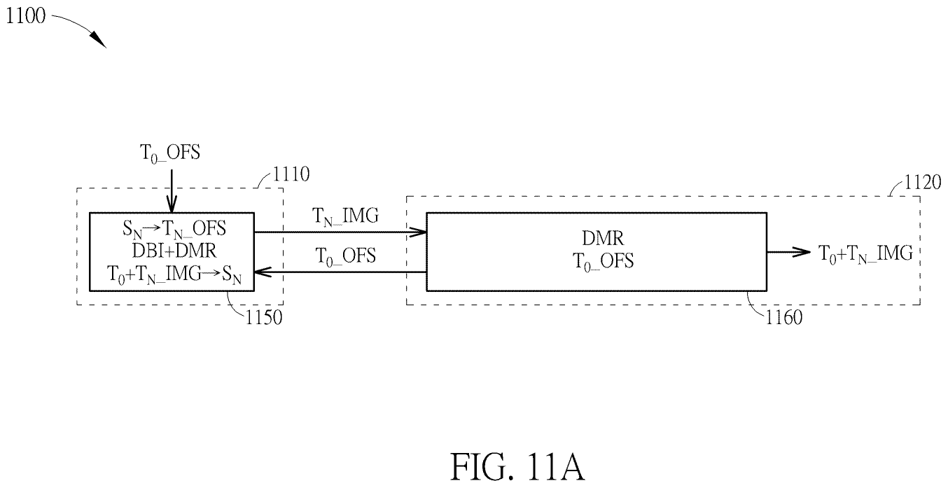

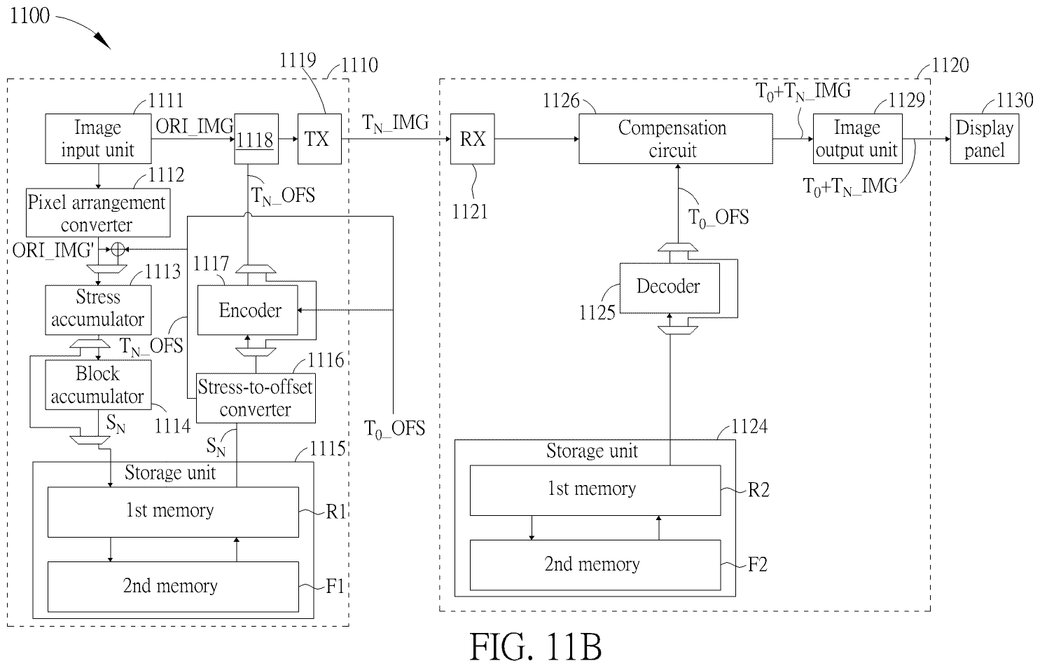

FIG. 11A is a schematic diagram of a display system 1100 according to an embodiment of the present invention. The display system 1100 includes an AP 1110 and a DDIC 1120, and a display panel may also be included but omitted in FIG. 11A for brevity. The AP 1110 may include a processing module 1150 for performing the accumulation of stress values and performing conversion to generate the main offset value T_{N}_OFS. In addition, the processing module 1150 may further perform deburn-in compensation (DBI) and demura compensation (DMR).

More specifically, after the AP 1110 accumulates the stress value STR to generate the accumulated stress value S_{N}, the accumulated stress value S_{N} is converted into the deburn-in offset value T_{N}_OFS. The AP 1110 may further compensate the original image data ORI_IMG by using the deburn-in offset value T_{N}_OFS to generate a deburn-in compensated image data T_{N}_IMG, and then send the deburn-in compensated image data T_{N}_IMG to the DDIC 1120. In addition, the processing module 1150 may further perform demura compensation. According to the information of the deburn-in offset value T_{N}_OFS and the demura offset value T₀_OFS (which may be obtained by taking a picture of the display panel or reading back the value from the DDIC 1120), the processing module 1150 may calculate the full-time compensated image data T₀+T_{N}_IMG and use it to perform stress value accumulation. Similarly, the full-time compensated image data T₀+T_{N}_IMG is closer to (or the same as) the image data actually sent to the display panel, and may generate a more accurate compensation result.

When the DDIC 1120 receives the deburn-in compensated image data T_{N}_IMG after the deburn-in compensation performed by the AP 1110, the demura circuit 1160 in the DDIC 1120 may perform demura compensation (DMR) on the image data T_{N}_IMG (using the demura offset value T₀_OFS), to finally generate the full-time compensated image data T₀+T_{N}_IMG, which may be provided to the display panel.

FIG. 11B illustrates a detailed implementation of the display system 1100. In addition to the AP 1110 and the DDIC 1120, the display system 1100 further includes a display panel 1130. Similarly, the display panel 1130 may be any type of panel, which may be an OLED panel or LCD panel, but not limited thereto.

As shown in FIG. 11B, the AP 1110 includes an image input unit 1111, a pixel arrangement converter 1112, a stress accumulator 1113, a block accumulator 1114, a storage unit 1115, a stress-to-offset converter 1116, an encoder 1117, a compensation unit 1118 and a transmitter (TX) 1119. Note that the structure of the AP 1110 is similar to the structure of the AP 1010, and the detailed operations of various circuits and modules included in the AP 1110 are similar to those in the AP 1010, which will not be repeated herein.

The difference between the AP 1110 and the AP 1010 is that, in the AP 1110, the compensation unit 1118 is deployed to replace the selector 1018. The compensation unit 1118 may compensate the original image data ORI_IMG by using the deburn-in offset value T_{N}_OFS, to generate the deburn-in compensated image data T_{N}_IMG, which is further output to the DDIC 1120.

The DDIC 1120 includes a receiver (RX) 1121, a storage unit 1124, a decoder 1125, a compensation circuit 1126 and an image output unit 1129. The detailed operations of various circuits and modules included in the DDIC 1120 are similar to those in the DDIC 1020, and will not be narrated herein. The difference between the DDIC 1120 and the DDIC 1020 is that, the selector 1022 originally included in the DDIC 1020 is omitted in the DDIC 1120. Since the DDIC 1120 would only receive the deburn-in compensated image data T_{N}_IMG from the AP 1110 without receiving any other offset value, the selector may not be necessary. In addition, since the deburn-in compensation is completed in the AP 1110, the compensation circuit 1126 of the DDIC 1120 may only perform demura compensation.

As mentioned above, the conventional deburn-in compensation scheme has the problem that the images actually displayed on the display panel may be different from the image data used for calculating the stress value, causing that the accumulated stress value could not accurately reflect the burn-in degree of the pixel. Therefore, in the embodiments shown in FIGS. 10A-10C and 11A-11B, this problem may be solved by deploying an additional demura compensation circuit in the AP. However, in these embodiments, the AP does not directly send the complete full-time compensated image data to the DDIC. This is because the well compensated image data are preferably finer data with 12 bits or more, but the MIPI interface has a bandwidth limit of 8 or 10 bit/channel and cannot timely forward such high-resolution data. Therefore, the AP may selectively send the deburn-in offset value T_{N}_OFS or the deburn-in compensated image data T_{N}_IMG to the DDIC, and then the DDIC completes the subsequent compensation process. The DDIC thereby generates the output image data with a higher resolution to optimize the visual effects.

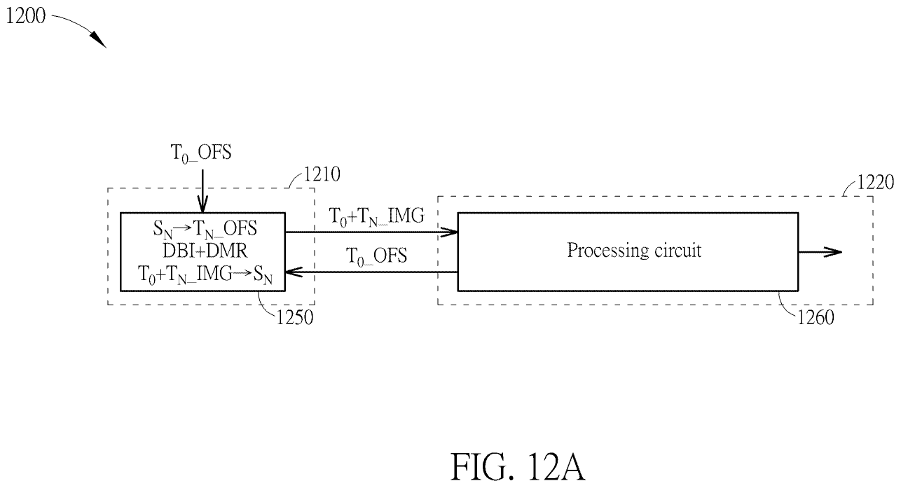

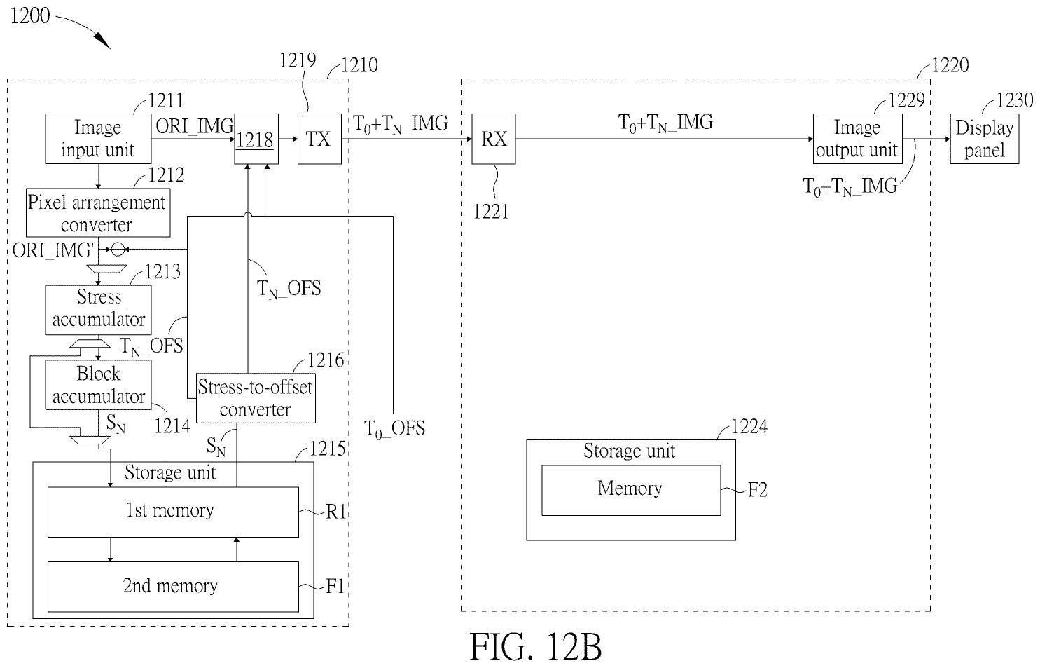

FIG. 12A is a schematic diagram of a display system 1200 according to an embodiment of the present invention. The display system 1200 includes an AP 1210 and a DDIC 1220, and a display panel may also be included but omitted in FIG. 12A for brevity. The AP 1210 may include a processing module 1250 for performing the accumulation of stress values and performing conversion to generate the main offset value T_{N}_OFS. In addition, the processing module 1250 may further perform deburn-in compensation (DBI) and demura compensation (DMR).

In this embodiment, the processing module 1250 may perform deburn-in compensation and demura compensation. Therefore, the accumulated stress value S_{N} may be converted into the corresponding deburn-in offset value T_{N}_OFS. In addition, the AP 1210 may obtain the information of the demura offset value T₀_OFS from the DDIC 1220 or another external memory or device. Subsequently, the processing module 1250 may perform compensation on the original image data ORI_IMG by using the deburn-in offset value T_{N}_OFS and the demura offset value T₀_OFS, to generate the full-time compensated image data T₀+T_{N}_IMG. The AP 1210 then sends the full-time compensated image data T₀+T_{N}_IMG to the DDIC 1220. Similarly, the full-time compensated image data T₀+T_{N}_IMG is used for performing stress value accumulation to generate the accumulated stress value S_{N}.

The DDIC 1220 includes a processing circuit 1260, which may include any other circuit module for performing other necessary image processing operations. Since the deburn-in and demura compensation have been performed in the AP 1210, and the image data received by the DDIC 1220 is the full-time compensated image data T₀+T_{N}_IMG, the DDIC 1220 may forward the full-time compensated image data T₀+T_{N}_IMG to the display panel without performing any other compensation.

In this embodiment, the AP 1210 and the DDIC 1220 may include a transmission interface with a larger bandwidth, which is sufficient to transmit image data with a higher resolution (e.g., 12 bits or more). Alternatively, if the specifications of the display allow for a slightly rougher image which only requires image data with 10-bit resolution, the compensated image data may be sent through the currently available MIPI interface. Or alternatively, there may be another compensation circuit included in the DDIC that could finely tune the received image data to achieve a higher image quality.

FIG. 12B illustrates a detailed implementation of the display system 1200. In addition to the AP 1210 and the DDIC 1220, the display system 1200 further includes a display panel 1230. Similarly, the display panel 1230 may be any type of panel, which may be an OLED panel or LCD panel, but not limited thereto.

As shown in FIG. 12B, the AP 1210 includes an image input unit 1211, a pixel arrangement converter 1212, a stress accumulator 1213, a block accumulator 1214, a storage unit 1215, a stress-to-offset converter 1216, a compensation unit 1218 and a transmitter (TX) 1219. Note that the structure of the AP 1210 is similar to the structure of the AP 1110, and the detailed operations of various circuits and modules included in the AP 1210 are similar to those in the AP 1110, which will not be repeated herein.

The difference between the AP 1210 and the AP 1110 is that, in the AP 1210, the compensation unit 1218 receives the deburn-in offset value T_{N}_OFS from the stress-to-offset converter 1216, and also receives the demura offset value T₀_OFS. In such a situation, the compensation unit 1218 may perform deburn-in compensation and demura compensation to generate the full-time compensated image data T₀+T_{N}_IMG. Therefore, the AP 1210 may output the full-time compensated image data T₀+T_{N}_IMG to the DDIC 1220. Correspondingly, since the image compensation is completed in the AP 1210, several compensation circuits and memories for deburn-in and demura may be omitted in the DDIC 1220.

In this embodiment, the DDIC 1220 includes a receiver (RX) 1221, a storage unit 1224 and an image output unit 1229. The detailed operations of various circuits and modules included in the DDIC 1220 are similar to those in the DDIC 1120, and will not be narrated herein. The difference between the DDIC 1220 and the DDIC 1120 is that, in the DDIC 1220, since the deburn-in compensation and demura compensation are not necessary, several compensation circuits, decoder and memory are omitted.

In various embodiments of the present invention, the pixel arrangement converter, stress accumulator, block accumulator, stress-to-offset converter and compensation unit in the AP may be implemented through software or hardware. The implementation of software may be, for example, writing corresponding algorithms in the program to implement the related functions through the execution of a processor. The implementation of hardware may be, for example, using the combination of logic operations in the circuitry to realize the related functions. In addition, the compensation circuit in the DDIC and the memories in the AP and DDIC may be implemented through hardware, where the first memory is usually a built-in memory such as a RAM, while the second memory may be built in or externally connected to the AP or DDIC, such as a flash memory.

In addition, the memory space required by the AP or the DDIC may be determined based on the resolution of the display panel, the block size, and the data depth of the corresponding stress value of each block or subpixel. In several embodiments, the data may also be required to include additional checksum bits to ensure that the stored and readout data are correct.

Note that the present invention aims at providing a cross-platform integrated solution to solve the full-time uneven phenomenon of the display, where the operations of the AP and the DDIC may be combined to realize deburn-in accumulation, calculation and compensation as well as demura compensation. Those skilled in the art may make modifications and alterations accordingly. For example, in the above embodiments, the image data for performing deburn-in and demura compensation in the AP or DDIC may be grayscale data; but in other embodiments, deburn-in and demura compensation may also be applied to voltages (e.g., gamma voltages) corresponding to the grayscale data, and the detailed compensation method should not limit the scope of the present invention. In addition, based on the configurations of the AP and the DDIC, the compensation data delivered between the AP and the DDIC (through MIPI) may include the accumulated stress value and/or the deburn-in offset value.

Also note that since the deburn-in offset value may be obtained by taking each subpixel as a unit (i.e., one block is equivalent to one subpixel), the data amount of the offset values that the AP needs to send to the DDIC is still quite large. In the above embodiments, the AP may be equipped with an encoder for compressing the deburn-in compensation data, which is stored in a compressed form before and after being sent to the DDIC, and is decompressed by a decoder of the DDIC when needing to be read out. In another embodiment, if the AP and DDIC have sufficient transmission bandwidth and the memory space of the DDIC is enough, the above encoder and decoder may also be omitted.

Besides, in several embodiments, the deburn-in compensation and demura compensation may be performed by the same compensation circuit. Alternatively, the DDIC may include a deburn-in compensation circuit for deburn-in compensation and a demura compensation circuit for demura compensation, where the deburn-in compensation circuit may be disabled or turned off if the compensation result is not satisfactory or if the deburn-in compensation is determined to be performed by the AP. In an embodiment, if the AP determines that the deburn-in compensation performance is not satisfactory, it may clear the present accumulated stress values, and restart the operations of stress value accumulation and offset value calculation.

The compensation scheme proposed by the present invention may be used to solve or improve the full-time uneven phenomenon of images on various display products. For example, the compensation schemes provided in this disclosure may be applied to a mobile phone. The resources in the AP of the mobile phone may be used to perform the accumulation and calculation of deburn-in stress values, and then deburn-in compensation and demura compensation may be performed through the AP or DDIC according to system requirements. The compensation schemes may also be applied to a product with a larger-scale display panel, such as a laptop or tablet computer, which may use the CPU resources of the computer to perform the accumulation and calculation of deburn-in stress values, and then deburn-in compensation and demura compensation may be performed through the CPU or DDIC according to system requirements. In fact, the embodiments of the present invention may be applied to any electronic product with a display device, which is not limited to the scope mentioned in this disclosure.

To sum up, the present invention provides a method used for a display system, to solve the full-time uneven phenomenon of the display images. According to the present invention, both the mura effect generated when the display panel leaves the factory and the burn-in phenomenon that continuously occurs during the usage of the panel may be solved. In the display system of the present invention, the host processor and the display driver circuit may cooperate to realize the deburn-in and demura compensation. In various embodiments of the present invention, the stress value accumulation may be performed in the host processor, to take advantage of the sufficient storage space and resources of the host processor. The compensation operations may be selectively performed in the host processor or the display driver circuit according to system requirements. As a result, a full-time compensated image data may be generated to improve the image uneven problem.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A display driver circuit, comprising:
a receiver to receive an original image data and a compensation data from a host processor;
a memory to store the compensation data; and
a compensation circuit, coupled to the memory and the receiver, to read out the compensation data from the memory, and compensate the original image data by using the compensation data to generate a first compensated image data.

2. The display driver circuit of claim 1, wherein the compensation data comprises an accumulated stress value or a deburn-in offset value.

3. The display driver circuit of claim 1, wherein the compensation data comprises an accumulated stress value, and the display driver circuit further comprises:
a stress-to-offset converter, coupled to the memory, to convert the accumulated stress value into a deburn-in offset value.

4. The display driver circuit of claim 1, wherein the compensation data comprises a deburn-in offset value, and the compensation circuit compensates the original image data by using the deburn-in offset value and a demura offset value.

5. The display driver circuit of claim 4, wherein the compensation circuit compensates the original image data by using the deburn-in offset value to generate the first compensated image data, and compensates the first compensated image data by using the demura offset value to generate a second compensated image data.

6. The display driver circuit of claim 1, wherein the compensation data comprises a main offset value, and the compensation circuit compensates the original image data by using the main offset value and an auxiliary offset value.

7. The display driver circuit of claim 6, wherein the main offset value is obtained in a first frequency and the auxiliary offset value is obtained in a second frequency greater than the first frequency.

8. A host processor, comprising:
a stress accumulator to generate a stress value according to an original image data and accumulate the stress value to generate an accumulated stress value; and
a transmitter, coupled to the stress accumulator, to send a compensation data corresponding to the accumulated stress value and send the original image data to a display driver circuit.

9. The host processor of claim 8, wherein the compensation data comprises the accumulated stress value or a deburn-in offset value generated from the accumulated stress value.

10. The host processor of claim 9, further comprising:
a stress-to-offset converter, coupled between the stress accumulator and the transmitter, to convert the accumulated stress value into the deburn-in offset value.

11. The host processor of claim 9, wherein the stress accumulator further receives the deburn-in offset value, and generates the stress value according to a compensated image data which is generated from the original image data compensated by the deburn-in offset value.

12. The host processor of claim 8, wherein the compensation data comprises a main offset value and an auxiliary offset value.

13. The host processor of claim 12, wherein the transmitter sends the main offset value in a first frequency and sends the auxiliary offset value in a second frequency greater than the first frequency.

14. The host processor of claim 8, further comprising:
a pixel arrangement converter, coupled to the stress accumulator, to convert the original image data into a pixel data corresponding to a display panel controlled by the display driver circuit;
wherein the stress accumulator generates the stress value according to the pixel data.

15. The host processor of claim 8, wherein the stress accumulator further receives a demura offset value, and generates the stress value according to a compensated image data which is generated from the original image data compensated by the demura offset value.

16. The host processor of claim 8, wherein the stress accumulator accumulates the stress value by taking a pixel or a subpixel as a unit.

17. A display system, comprising:
a host processor, comprising:
a stress accumulator to generate a stress value according to an original image data and accumulate the stress value to generate an accumulated stress value; and
a transmitter, coupled to the stress accumulator, to output a compensation data corresponding to the accumulated stress value and output the original image data; and
a display driver circuit, comprising:
a receiver to receive the original image data and the compensation data from the host processor;
a memory to store the compensation data; and
a compensation circuit, coupled to the memory and the receiver, to read out the compensation data from the memory, and compensate the original image data by using the compensation data to generate a compensated image data.

18. The display system of claim 17, wherein the compensation data comprises the accumulated stress value or a deburn-in offset value generated from the accumulated stress value.

19. The display system of claim 17, wherein the compensation data comprises a deburn-in offset value, and the compensation circuit compensates the original image data by using the deburn-in offset value and a demura offset value.

20. The display system of claim 17, wherein the stress accumulator further receives the deburn-in offset value, and generates the stress value according to the compensated image data which is generated from the original image data compensated by the deburn-in offset value.

21. A display driver circuit, comprising:
a receiver to receive an original image data from a host processor through a first interface;
a memory to receive a compensation data from the host processor through a second interface, and store the compensation data; and
a compensation circuit, coupled to the memory and the receiver, to read out the compensation data from the memory, and compensate the original image data by using the compensation data to generate a first compensated image data.

22. The display driver circuit of claim 21, wherein the compensation data comprises an accumulated stress value or a deburn-in offset value.

23. The display driver circuit of claim 21, wherein the first interface is a mobile industry processor interface (MIPI), and the second interface is a serial peripheral interface (SPI).

24. The display driver circuit of claim 21, wherein the compensation data is sent to the memory by the host processor without through the receiver.

25. The display driver circuit of claim 21, wherein the compensation data comprises an accumulated stress value, and the display driver circuit further comprises:
a stress-to-offset converter, coupled to the memory, to convert the accumulated stress value into a deburn-in offset value.

26. The display driver circuit of claim 21, wherein the compensation data comprises a deburn-in offset value, and the compensation circuit compensates the original image data by using the deburn-in offset value and a demura offset value.

27. The display driver circuit of claim 26, wherein the compensation circuit compensates the original image data by using the deburn-in offset value to generate the first compensated image data, and compensates the first compensated image data by using the demura offset value to generate a second compensated image data.

28. A host processor, comprising:
a stress accumulator to generate a stress value according to an original image data and accumulate the stress value to generate an accumulated stress value;
a first transmitter to send the original image data to a display driver circuit; and
a second transmitter, coupled to the stress accumulator, to send a compensation data corresponding to the accumulated stress value to the display driver circuit.

29. The host processor of claim 28, wherein the compensation data comprises the accumulated stress value or a deburn-in offset value generated from the accumulated stress value.

30. The host processor of claim 29, further comprising:
a stress-to-offset converter, coupled between the stress accumulator and the second transmitter, to convert the accumulated stress value into the deburn-in offset value.

31. The host processor of claim 29, wherein the stress accumulator further receives the deburn-in offset value, and generates the stress value according to a compensated image data which is generated from the original image data compensated by the deburn-in offset value.

32. The host processor of claim 28, wherein the first transmitter sends the original image data through a mobile industry processor interface (MIPI), and the second transmitter sends the compensation data through a serial peripheral interface (SPI).

33. The host processor of claim 28, wherein the second transmitter sends the compensation data by accessing a memory of the display driver circuit.

34. The host processor of claim 28, further comprising:
a pixel arrangement converter, coupled to the stress accumulator, to convert the original image data into a pixel data corresponding to a display panel controlled by the display driver circuit;
wherein the stress accumulator generates the stress value according to the pixel data.

35. The host processor of claim 28, wherein the stress accumulator further receives a demura offset value, and generates the stress value according to a compensated image data which is generated from the original image data compensated by the demura offset value.

36. The host processor of claim 28, wherein the stress accumulator accumulates the stress value by taking a pixel or a subpixel as a unit.

37. A display system, comprising:
a host processor, comprising:
a stress accumulator to generate a stress value according to an original image data and accumulate the stress value to generate an accumulated stress value;
a first transmitter to output the original image data through a first interface; and
a second transmitter, coupled to the stress accumulator, to output a compensation data corresponding to the accumulated stress value through a second interface; and
a display driver circuit, comprising:
a receiver to receive the original image data from the host processor through the first interface;
a memory to receive the compensation data from the host processor through the second interface, and store the compensation data; and
a compensation circuit, coupled to the memory and the receiver, to read out the compensation data from the memory, and compensate the original image data by using the compensation data to generate a compensated image data.

38. The display system of claim 37, wherein the compensation data comprises the accumulated stress value or a deburn-in offset value generated from the accumulated stress value.

39. The display system of claim 37, wherein the compensation data comprises a deburn-in offset value, and the compensation circuit compensates the original image data by using the deburn-in offset value and a demura offset value.

40. The display system of claim 37, wherein the stress accumulator further receives the deburn-in offset value, and generates the stress value according to the compensated image data which is generated from the original image data compensated by the deburn-in offset value.
